(19) United States
(12) Patent Application Publication
(10) Pub. No.: US 2026/0368869 A1
(43) Pub. Date: Nov. 19, 2026

(54) IMAGE ENHANCEMENT METHOD AND APPARATUS, ELECTRONIC DEVICE, AND STORAGE MEDIUM

(71) Applicants: UNIVERSITY OF SCIENCE AND TECHNOLOGY OF CHINA, Hefei, Anhui (CN); WUHU STATE-OWNED FACTORY OF MACHINING, Wuhu, Anhui (CN)

(72) Inventors: Huaian CHEN, Hefei (CN); Yi JIN, Hefei (CN); Tianle LIU, Hefei (CN); Xin FAN, Wuhu (CN)

(73) Assignees: UNIVERSITY OF SCIENCE AND TECHNOLOGY OF CHINA, Hefei, Anhui (CN); WUHU STATE-OWNED FACTORY OF MACHINING, Wuhu, Anhui (CN)

(21) Appl. No.: 19/476,120

(22) PCT Filed: Mar. 12, 2024
(86) PCT No.: PCT/CN2024/081100

§ 371 Date: Oct. 16, 2025

(30) Foreign Application Priority Data
Apr. 17, 2023 (CN) 202310424938.5

(51) Int. Cl. G06T 5/94; G06N 3/08; G06T 5/70; G06T 5/92; G06V 10/60; H04N 1/60

(52) U.S. Cl. CPC G06T 5/94; G06N 3/08; G06T 5/70; G06T 5/92; G06V 10/60; H04N 1/60; G06T 2207/20081; G06T 2207/20182

(57) ABSTRACT

Provided is an image enhancement method and apparatus, an electronic device, and a storage medium. The method includes: obtaining a to-be-processed single low-light image (LLI); inputting the to-be-processed single LLI into an image enhancement network (IEN), where the IEN is obtained by training a zero-shot learning (ZSL) enhancer by defining a prior-guided regularization loss; and obtaining an expected exposure image output by the IEN with respect to the to-be-processed single LLI. Provided is a flexible and controllable ZSL enhancer, which can learn an expected exposure image, requires only a single LLI itself, and does not depend on a statistical feature of training data, and therefore has a good generalization capability for a real scene. Correspondingly, an IEN constructed based on the ZSL enhancer needs to be trained by simply inputting a single LLI to learn the expected exposure image.

### CROSS REFERENCE TO RELATED APPLICATION

This application is a national stage application of International Patent Application No. PCT/CN2024/081100, filed on Mar. 12, 2024, which claims the benefit and priority of Chinese Patent Application No. 202310424938.5, filed with the China National Intellectual Property Administration on Apr. 17, 2023 and entitled “IMAGE ENHANCEMENT METHOD AND APPARATUS, ELECTRONIC DEVICE, AND STORAGE MEDIUM”, the disclosure of which is incorporated by reference herein in its entirety as part of the present application.

### TECHNICAL FIELD

The present disclosure relates to the field of image enhancement technologies, and more specifically, to an image enhancement method and apparatus, an electronic device, and a storage medium.

### BACKGROUND

An image photographed in a low-light environment typically has severe visual degradation, such as low brightness, color distortion, and a blurred texture. To resolve this problem, mainstream research approaches employ supervised learning (SL) for low-light image enhancement (LLIE), and these models are trained using carefully acquired datasets containing a large quantity of paired low-light/normal-light images. Although these methods achieve significant performance, a key problem is that a large quantity of paired images need to be acquired for these methods, which is cumbersome and time consuming. In addition, unlike an advanced visual task in which a label is clearly defined, a definition of a true image (namely, a normal-light image) in an LLIE task is subjective and fuzzy, which affects a representation of an enhanced image, making the representation more difficult to achieve a satisfactory generalization capability.

To alleviate the foregoing problem, many unsupervised learning methods are developed. Usually, these methods mainly include two research approaches. In one research approach, training is performed by using an unpaired low-light/normal-light paired image. A low-light image (LLI) is used for coarse enhancement and an unpaired image is used to refine a global style through adversarial learning. In the other research approach, multiple LLIs are used for training. Image prior is used to help restore a normal-light image. The two research approaches can achieve good visibility. However, to achieve satisfactory performance, data distribution of an external LLI (and normal-light) image used for training needs to be highly correlated with a test image captured from a real scene, otherwise a generalization capability of an LLIE model cannot be ensured.

### SUMMARY

In view of this, to resolve the foregoing problem, the present disclosure provides an image enhancement method and apparatus, an electronic device, and a storage medium. Technical solutions are as follows:

An image enhancement method is provided, and the method includes:
obtaining a to-be-processed single LLI;
inputting the to-be-processed single LLI into an image enhancement network (IEN), where the IEN is obtained by training a zero-shot learning (ZSL) enhancer by defining a prior-guided regularization loss; and obtaining an expected exposure image output by the IEN with respect to the to-be-processed single LLI.

Preferably, a process of training the ZSL enhancer by defining the prior-guided regularization loss to obtain the IEN includes:
constructing the ZSL enhancer:

$$\overline{R} = arg {m}_{\overline{R}} in {‖ I - ( \overline{R} ∘ \overline{L} - N ) ‖}^{2} + {λ}_{1} ψ ( \overline{R} ) + {λ}_{2} φ ( \overline{L} ) + {λ}_{3} ϕ ( N ) ,$$

where
ψ(R̅)=λ_{T}ψ_{T}(R̅)+λ_{C}ψ_{c}(R̅)+λ_{I}ψ_{I}(R̅); R̅ is the output expected exposure image; L̅ is an output illumination ratio map (IRM), and meets a piecewise smoothness constraint, L̅=L/\tilde{L}, L is an illumination map, and \tilde{L} is desired illumination; I is an input single LLI, R̅=R∘\tilde{L}, and R is a reflectance map; N is an output noise map; ψ(R̅), φ(L̅), and φ(N) are respectively regularization terms of the output expected exposure image, the output IRM, and the output noise map; λ₁, λ₂, and λ₃ are respectively balance weights of ψ(R̅), φ(L̅), and φ(N), λ₁ is set to 1, λ₂ is set to 0.5, and λ₃ is set to 0.1; and ψ_{T}(R̅), ψ_{c}(R̅), and ψ_{I}(R̅) are respectively a texture regularization term, a color regularization term, and an illumination regularization term; constructing a loss function of the ZSL enhancer:

Lₐₗₗ=L_{rec}+λ₂L_{L̅}+λ₃L_{N}+λ_{T}L_{T}+λ_{C}L_{C}+λ_{I}L_{I}, where
Lₐₗₗ is an overall loss function; L_{rec} is a reconstruction loss, and L_{rec}=∥I−(R̅∘L̅+N)∥²; L_{L̅} is a regularization loss of the illumination map, L_{L̅}=∥∇I∘ exp(−λ_{g}∇R̅)∥, ∇ is a gradient operator, λ_{g} is a balance factor, and λ_{g} is set to 10; L_{N} is a regularization loss of the output noise map, L_{N}=∥M(N)∥, and M(•) is a function for calculating an input mean; L_{T} is a texture loss, L_{T}=∥F(R̅^{γt})−F(D(T(I)))∥², F(•) is a feature extractor, T(•) is a light transformation, D(•) is a denoising operation, and γt is a learnable factor; L_{C} is a color loss,

$${L}_{C} = , {\sum }_{i = r , g , b} {‖ M ( H ( {\overline{R}}_{i} ) ) - M ( {I}_{i} ) ‖}^{2} + {λ}_{cf} ‖ {E}_{n} - ( v + ω \times μ ) ‖ ,$$

$$μ = \sqrt{{M ( \vert {\overline{R}}_{r} - {\overline{R}}_{g} \vert )}^{2} + {M ( \vert {\overline{R}}_{r} + {\overline{R}}_{g} \vert / 2 - {\overline{R}}_{b} )}^{2}} ,$$

$$v = \sqrt{{S ( \vert {\overline{R}}_{r} - {\overline{R}}_{g} \vert )}^{2} + {S ( \vert {\overline{R}}_{r} + {\overline{R}}_{g} \vert / 2 - {\overline{R}}_{b} )}^{2}} ,$$

H(R̅ᵢ)=(αR̅ᵢ)^{β} is a pixel-to-pixel conversion function, α and β are learnable parameters, and S(•) is a function for calculating an input variance; R̅ᵢ∈{R̅ᵣ,R̅_{g},R̅_{b}} are r, g, and b channels corresponding to R̅, and Iᵢ∈{Iᵣ,I_{g},I_{b}} are r, g, and b channels corresponding to I; λ_{cf} is a constant parameter used to enhance an image color, and is set to 0.025; Eₙ is a constant parameter used to determine a color level of an image, and is set to 0.32; ω is a weight parameter, and is set to 0.3; L_{I} is an illumination loss,

$${L}_{I} = ‖ M ( \overline{R} ) - ε ‖ - {λ}_{il} {\sum }_{i = 1}^{B} S ( {δ}^{i} ( \overline{R} ) ) ,$$

δ(•) is an operation of generating a local image from an input image, B is a quantity of image blocks, λᵢₗ is a parameter used to balance a local contrast of the expected exposure image, and λᵢₗ is set to 2; and ε is a constant parameter set in a range of [0.25, 0.75]; and
training the ZSL enhancer by iteratively optimizing the loss function of the ZSL enhancer, and using the trained ZSL enhancer as the IEN.

Preferably, the training the ZSL enhancer includes:
performing a first stage of training on the ZSL enhancer in a manner of input-guided enhancement, including: obtaining a single LLI used for iterative training; and inputting the single LLI used for iterative training into the ZSL enhancer to obtain a corresponding expected exposure image; and
performing a second stage of training on the ZSL enhancer in a manner of output-guided refinement, including:
storing, in a historical data pool, an expected exposure image obtained through each iterative training in the first stage, and using, as a rough enhanced exposure image output in the first stage, an average value of multiple expected exposure images stored closest to a current moment in the historical data pool; inputting the rough enhanced exposure image into the ZSL enhancer to obtain a corresponding expected exposure image; and storing, in the historical data pool, expected exposure images obtained through each iterative training in the second stage.
Preferably, the light transformation T(•) is gamma correction, and the denoising operation D(•) is a zero-shot denoising operation.

An image enhancement apparatus, and the apparatus includes:
an image obtaining module configured to obtain a to-be-processed single LLI; and
an image enhancement module configured to input the to-be-processed single LLI into an IEN, where the IEN is obtained by training a ZSL enhancer by defining a prior-guided regularization loss; and obtain an expected exposure image output by the IEN with respect to the to-be-processed single LLI.

Preferably, a process of training, by the image enhancement module, the ZSL enhancer by defining the prior-guided regularization loss to obtain the IEN includes:
constructing the ZSL enhancer:

$$\overline{R} = arg {m}_{\overline{R}} in {‖ I - ( \overline{R} ∘ \overline{L} - N ) ‖}^{2} + {λ}_{1} ψ ( \overline{R} ) + {λ}_{2} φ ( \overline{L} ) + {λ}_{3} ϕ ( N ) ,$$

where
ψ(R̅)=λ_{T}ψ_{T}(R̅)+λ_{C}ψ_{c}(R̅)+λ_{I}ψ_{I}(R̅); R̅ is the output expected exposure image; L̅ is an output IRM, and meets a piecewise smoothness constraint, L̅=L/\tilde{L}, L is an illumination map, and \tilde{L} is desired illumination; I is an input single LLI, R̅=R∘\tilde{L}, and R is a reflectance map; N is an output noise map; ψ(R̅), φ(L̅), and φ(N) are respectively regularization terms of the output expected exposure image, the output IRM, and the output noise map; λ₁, λ₂, and λ₃ are respectively balance weights of ψ(R̅), φ(L̅), and φ(N), λ₁ is set to 1, λ₂ is set to 0.5, and λ₃ is set to 0.1; and ψ_{T}(R̅), ψ_{c}(R̅), and ψ_{I}(R̅) are respectively a texture regularization term, a color regularization term, and an illumination regularization term;
constructing a loss function of the ZSL enhancer:

Lₐₗₗ=L_{rec}+λ₂L_{L̅}+λ₃L_{N}+λ_{T}L_{T}+λ_{C}L_{C}+λ_{I}L_{I}, where
Lₐₗₗ is an overall loss function; L_{rec} is a reconstruction loss, and L_{rec}=∥I−(R̅∘L̅+N)∥²; L_{L̅} is a regularization loss of the illumination map, L_{L̅}=∥∇I∘ exp(−λ_{g}∇R̅)∥, ∇ is a gradient operator, λ_{g} is a balance factor, and λ_{g} is set to 10; L_{N} is a regularization loss of the output noise map, L_{N}=∥M(N)∥, and M(•) is a function for calculating an input mean; L_{T} is a texture loss, L_{T}=∥F(R̅^{γt})−F(D(T(I)))∥², F(•) is a feature extractor, T(•) is a light transformation, D(•) is a denoising operation, and γt is a learnable factor; L_{C} is a color loss,

$${L}_{C} = {\sum }_{i = r , g , b} {‖ M ( H ( {\overline{R}}_{i} ) ) - M ( {I}_{i} ) ‖}^{2} + {λ}_{cf} ‖ {E}_{n} - ( v + ω \times μ ) ‖ ,$$

$$μ = \sqrt{{M ( \vert {\overline{R}}_{r} - {\overline{R}}_{g} \vert )}^{2} + {M ( \vert {\overline{R}}_{r} + {\overline{R}}_{g} \vert / 2 - {\overline{R}}_{b} )}^{2}} , \\ v = \sqrt{{S ( \vert {\overline{R}}_{r} - {\overline{R}}_{g} \vert )}^{2} + {S ( \vert {\overline{R}}_{r} + {\overline{R}}_{g} \vert / 2 - {\overline{R}}_{b} )}^{2}} ,$$

H(R̅ᵢ)=(αR̅ᵢ)^{β} is a pixel-to-pixel conversion function, α and β are learnable parameters, and S(•) is a function for calculating an input variance; R̅ᵢ∈{R̅ᵣ,R̅_{g},R̅_{b}} are r, g, and b channels corresponding to R̅, and Iᵢ∈{Iᵣ,I_{g},I_{b}} are r, g, and b channels corresponding to I; λ_{cf} is a constant parameter used to enhance an image color, and is set to 0.025; Eₙ is a constant parameter used to determine a color level of an image, and is set to 0.32; ω is a weight parameter, and is set to 0.3; L_{I} is an illumination loss,

$${L}_{I} = ‖ M ( \overline{R} ) - ε ‖ - {λ}_{il} {\sum }_{i = 1}^{B} S ( {δ}^{i} ( \overline{R} ) ) ,$$

δ(•) is an illumination loss, is an operation of generating a local image from an input image, B is a quantity of image blocks, λᵢₗ is a parameter used to balance a local contrast of the expected exposure image, and λᵢₗ is set to 2; and ε is a constant parameter set in a range of [0.25, 0.75]; and
training the ZSL enhancer by iteratively optimizing the loss function of the ZSL enhancer, and using the trained ZSL enhancer as the IEN.

Preferably, a process of training, by the image enhancement module, the ZSL enhancer includes:
performing a first stage of training on the ZSL enhancer in a manner of input-guided enhancement, including: obtaining a single LLI used for iterative training; and inputting the single LLI used for iterative training into the ZSL enhancer to obtain a corresponding expected exposure image; and
performing a second stage of training on the ZSL enhancer in a manner of output-guided refinement, including:
storing, in a historical data pool, an expected exposure image obtained through each iterative training in the first stage, and using, as a rough enhanced exposure image output in the first stage, an average value of multiple expected exposure images stored closest to a current moment in the historical data pool; inputting the rough enhanced exposure image into the ZSL enhancer to obtain a corresponding expected exposure image; and storing, in the historical data pool, expected exposure images obtained through each iterative training in the second stage.
Preferably, the light transformation T(•) is gamma correction, and the denoising operation D(•) is a zero-shot denoising operation.
An electronic device is provided. The electronic device includes: at least one memory and at least one processor, the memory stores an application program, the processor invokes the application program stored in the memory, and the application program is used to implement the image enhancement method.
A storage medium is provided. The storage medium stores computer program code, and when being executed, the computer program code implements the image enhancement method.
In comparison with the conventional technology, beneficial effects achieved in the present disclosure are as follows:
The present disclosure provides an image enhancement method and apparatus, an electronic device, and a storage medium. The method includes: obtaining a to-be-processed single LLI; inputting the to-be-processed single LLI into an IEN, where the IEN is obtained by training a ZSL enhancer by defining a prior-guided regularization loss; and obtaining an expected exposure image output by the IEN with respect to the to-be-processed single LLI. Provided is a flexible and controllable ZSL enhancer, which can learn an expected exposure image, requires only a single LLI itself, and does not depend on a statistical feature of training data, and therefore has a good generalization capability for a real scene. Correspondingly, an IEN constructed based on the ZSL enhancer needs to be trained by simply inputting a single LLI to learn the expected exposure image.

### BRIEF DESCRIPTION OF THE DRAWINGS

To describe the technical solutions in the embodiments of the present disclosure or in the conventional technology more clearly, the accompanying drawings required for describing the embodiments or the conventional technology will be briefly described below. Apparently, the accompanying drawings in the following description merely show the embodiments of the present disclosure, and those of ordinary skill in the art can still derive other accompanying drawings from the provided accompanying drawings without creative efforts.

FIG. 1 is a method flowchart of an image enhancement method according to an embodiment of the present disclosure;

FIG. 2 is a schematic structural diagram of an IEN according to an embodiment of the present disclosure;

FIGS. 3A-3H are schematic diagrams of analysis of parameters λ_{cf} and λᵢₗ according to an embodiment of the present disclosure;

FIGS. 4A-4P and FIGS. 5A-5P show a result of a visualization comparison between an IEN according to an embodiment of the present disclosure and another LLIE model;

FIG. 6A-6X show a result of a visibility comparison between an IEN according to an embodiment of the present disclosure and another LLIE model on a non-reference dataset; and

FIG. 7 is a schematic structural diagram of an image enhancement apparatus according to an embodiment of the present disclosure.

### DETAILED DESCRIPTION OF THE EMBODIMENTS

The technical solutions of the embodiments of the present disclosure are clearly and completely described below with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

To make objectives, features, and advantages of the present disclosure more comprehensible, the following describes the present disclosure in more detail with reference to accompanying drawings and specific implementations.

In the conventional technology, to resolve a problem of visual degradation in an LLI, the inventors found that:

Researchers proposed many methods, mainly including a non-learning method, an SL method, and an unsupervised learning method.

The non-learning method includes, for example, a gamma correction-based method, a histogram equalization-based method, and a Retinex-based method. In the gamma correction-based method, light of an image is converted by using a gamma curve, and this can increase a contrast of the image, but is prone to cause overexposure or underexposure. In the histogram equalization-based method, a histogram of an LLI is first calculated, and then a contrast of the image is increased by stretching a dynamic range. This method is simple and effective, but is easy to amplify a local noise. In the Retinex-based method, an LLI is decomposed into an illumination map and a reflectance map, and then the reflectance map is used as a final enhanced image. This technology enhances detail and naturalness of the enhanced image, but is still susceptible to an impact of a strong noise.

In recent years, the SL method has dominated research on an LLIE task. A low-light net (LLNet) is an earliest attempt, which uses a depth autoencoder trained by combining a dark image, to implement image enhancement. Inspired by this work, a synthetic dataset is used in many studies to train an LLIE model. However, the synthetic dataset does not reflect a feature of a real LLI, which limits applicability of these methods in a real scene. To resolve this problem, Wei et al. acquire a low-light dataset (low-light dataset, LOL) including paired low-light/normal-light images. Yang et al. expand the LOL dataset and constructs a larger low-light paired image dataset, which has a more real scene. Chen et al. introduce a real paired image dataset, which includes a raw short exposure LLI and a corresponding long exposure reference image. Based on these real pairing datasets, more SL methods have been proposed. For example, Zhang et al. propose kindling the darkness (KinD) and kindling the darkness plus (KinD++), which can illuminate a dark area and also remove a hidden artifact. Xu et al use a signal-to-noise ratio (SNR)-perception transformer and a convolution model to dynamically enhance pixels with a spatial transformation operation. Although these methods have made great breakthrough in enhancing quality, these methods rely on large-scale datasets of paired low-light/normal-light images, and it is extremely time-consuming to obtain these paired images.

To reduce a requirement for paired low-light/normal-light images, many efforts are devoted to developing the unsupervised learning method. Typically, Jiang et al. propose a heuristic adversarial network, which is a lightweight but effective single path generation adversarial network. Ni et al. propose an unsupervised enhancement generative adversarial network (UEGAN), which learns a corresponding image-to-image mapping from a group of images with required features. Jin et al. integrate a decomposition network and an optical effect suppression network in a unified framework, implementing unsupervised night image enhancement. These methods take full advantage of unpaired images, and yield encouraging results. Furthermore, some methods attempt to implement unsupervised LLIE by using only an LLI. For example, Guo et al propose zero-reference deep curve estimation (Zero-DCE++), in which LLIE is defined as a task for image-specific curve estimation. Liu et al propose a retinex-inspired unrolling with architecture search (RUAS) method, in which unsupervised learning is implemented by designing a cooperative reference-free learning policy. In the foregoing methods, relatively good enhancement quality can be obtained. However, large-scale training images still need to be acquired in the methods. Recently, in two papers, an LLIE model based on deep image prior (DIP) for single LLI training is further developed. However, DIP focuses primarily on restoration of an overall texture and a color of an image, and does not effectively restore ideal illumination.

To resolve the foregoing problem in the conventional technology, the present disclosure proposes an image enhancement method for learning an expected exposure image from a single LLI, and an image with desired exposure can be restored by giving an LLI and expected brightness without training a dataset.

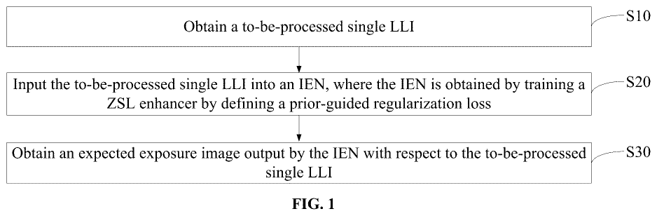

Refer to FIG. 1. FIG. 1 is a method flowchart of an image enhancement method according to an embodiment of the present disclosure. As shown in FIG. 1, the image enhancement method includes the following steps:

S10. Obtain a to-be-processed single LLI.

In this embodiment of the present disclosure, the to-be-processed single LLI is an image photographed in a low-light environment, and may be specified by a user.

S20. Input the to-be-processed single LLI into an IEN, where the IEN is obtained by training a ZSL enhancer by defining a prior-guided regularization loss.

In this embodiment of the present disclosure, a flexible and controllable ZSL enhancer is proposed, which can learn an expected exposure image, and only needs to input an LLI itself. The ZSL enhancer does not depend on a statistical feature of training data, and therefore has a good generalization capability for a real scene.

For this, the present disclosure proposes a set of prior-guided regularization losses based on illumination prior and natural image prior, in which a learnable flexibility factor is introduced to reduce an adverse impact of a light difference between an LLI and an enhanced image.

The present disclosure proposes an image enhancement policy for learning an expected exposure image from a single LLI, and constructs an IEN learning an expected exposure image from a single LLI. In an LLIE task, a definition of normal illumination is subjective, and a potential color and texture of an image are objectively determined by a scene. Inspired by this, the ZSL enhancer proposed by the present disclosure introduces expected illumination to restore an expected exposure image and utilizes a natural image before learning a potential color and a texture from an input LLI itself. From this point of view, the present disclosure formulates a set of prior-guided regularization losses, and designs two-stage progressive learning schemes for step-by-step training of the ZSL enhancer, to help enhance the image to achieve a clear texture, a vivid color, and adjustable light.

Based on this, a process of training the ZSL enhancer by defining the prior-guided regularization loss to obtain the IEN includes the following steps:
constructing the ZSL enhancer:

$$\overline{R} = arg {m}_{\overline{R}} in {‖ I - ( \overline{R} ∘ \overline{L} - N ) ‖}^{2} + {λ}_{1} ψ ( \overline{R} ) + {λ}_{2} φ ( \overline{L} ) + {λ}_{3} ϕ ( N ) ,$$

where
ψ(R̅)=λ_{T}ψ_{T}(R̅)+λ_{C}ψ_{c}(R̅)+λ_{I}ψ_{I}(R̅); R̅ is the output expected exposure image; L̅ is an output illumination ratio map (IRM), and meets a piecewise smoothness constraint, L̅=L/\tilde{L}, L is an illumination map, and \tilde{L} is desired illumination; I is an input single LLI, R̅=R∘\tilde{L}, and R is a reflectance map; N is an output noise map; ψ(R̅), φ(L̅), and φ(N) are respectively regularization terms of the output expected exposure image, the output IRM, and the output noise map; λ₁, λ₂, and λ₃ are respectively balance weights of ψ(R̅), φ(L̅), and φ(N), λ₁ is set to 1, λ₂ is set to 0.5, and λ₃ is set to 0.1; and ψ_{T}(R̅), ψ_{c}(R̅), and ψ_{I}(R̅) are respectively a texture regularization term, a color regularization term, and an illumination regularization term;
constructing a loss function of the ZSL enhancer:

Lₐₗₗ=L_{rec}+λ₂L_{L̅}+λ₃L_{N}+λ_{T}L_{T}+λ_{C}L_{C}+λ_{I}L_{I}, where
Lₐₗₗ is an overall loss function; L_{rec} is a reconstruction loss, and L_{rec}=∥I−(R̅∘L̅+N)∥²; L_{L̅} is a regularization loss of the illumination map, L_{L̅}=∥∇I∘ exp(−λ_{g}∇R̅)∥, ∇ is a gradient operator, λ_{g} is a balance factor, and λ_{g} is set to 10; L_{N} is a regularization loss of the output noise map, L_{N}=∥M(N)∥, and M(•) is a function for calculating an input mean; L_{T} is a texture loss, L_{T}=∥F(R̅^{γt})−F(D(T(I)))∥², F(•) is a feature extractor, T(•) is a light transformation, D(•) is a denoising operation, and γt is a learnable factor; L_{C} is a color loss,

$${L}_{C} = {\sum }_{i = r , g , b} {‖ M ( H ( {\overline{R}}_{i} ) ) - M ( {I}_{i} ) ‖}^{2} + {λ}_{cf} ‖ {E}_{n} - ( v + ω \times μ ) ‖ ,$$

$$μ = \sqrt{{M ( \vert {\overline{R}}_{r} - {\overline{R}}_{g} \vert )}^{2} + {M ( \vert {\overline{R}}_{r} + {\overline{R}}_{g} \vert / 2 - {\overline{R}}_{b} )}^{2}} , \\ v = \sqrt{{S ( \vert {\overline{R}}_{r} - {\overline{R}}_{g} \vert )}^{2} + {S ( \vert {\overline{R}}_{r} + {\overline{R}}_{g} \vert / 2 - {\overline{R}}_{b} )}^{2}} ,$$

H(R̅ᵢ)=(αR̅ᵢ)^{β} is a pixel-to-pixel conversion function, α and β are learnable parameters, and S(•) is a function for calculating an input variance; R̅ᵢ∈{R̅ᵣ,R̅_{g},R̅_{b}} are r, g, and b channels corresponding to R̅, and Iᵢ∈{Iᵣ,I_{g},I_{b}} are r, g, and b channels corresponding to I; λ_{cf} is a constant parameter used to enhance an image color, and is set to 0.025; Eₙ is a constant parameter used to determine a color level of an image, and is set to 0.32; ω is a weight parameter, and is set to 0.3; L_{I} is an illumination loss,

$${L}_{I} = ‖ M ( \overline{R} ) - ε ‖ - {λ}_{il} {\sum }_{i = 1}^{B} S ( {δ}^{i} ( \overline{R} ) ) ,$$

δ(•) is an operation of generating a local image from an input image, B is a quantity of image blocks, λᵢₗ is a parameter used to balance a local contrast of the expected exposure image, and λᵢₗ is set to 2; and ε is a constant parameter set in a range of [0.25, 0.75]; and training the ZSL enhancer by iteratively optimizing the loss function of the ZSL enhancer, and using the trained ZSL enhancer as the IEN.

In a specific implementation process: (1) A process of constructing an image enhancer learning an expected exposure image from a single LLI may include the following procedure:

The present disclosure is based on an image enhancement policy learning an expected exposure image from a single LLI, and constructs the IEN learning the expected exposure image from the single LLI by using the ZSL enhancer. Based on the Retinex theory, the LLI may be modeled as:

I=R∘L+N (1), where
I is a low-light input image, R is a reflectance map, L is an illumination map, N is a noise map, and ∘ is an element-by-element multiplication. An LLI I is given, and an LLIE task is to restore the LLI to a normal-light image. However, as noted above, a definition of a normal-light image is quite subjective. To resolve this problem, the present disclosure introduces desired illumination \tilde{L} and aims to restore an image R with desired exposure. Based on this, formula (1) may be restated as:

I=R∘\tilde{L}∘(L/\tilde{L})+N=R̅∘\tilde{L}+N (2), where
R̅=R∘\tilde{L} is an expected exposure image, and L̅=L/\tilde{L} is an IRM meeting a piecewise smoothness constraint. The present disclosure can then restore R̅ from I by resolving a regularization minimization problem:

$$\overline{R} = arg {m}_{\overline{R}} in {‖ I - ( \overline{R} ∘ \overline{L} - N ) ‖}^{2} + {λ}_{1} ψ ( \overline{R} ) + {λ}_{2} φ ( \overline{L} ) + {λ}_{3} ϕ ( N ) , \qquad ( 3 )$$

ψ(R̅), φ(L̅), and φ(N) are respectively regularization terms of the expected exposure image, the IRM, and the noise map, and λ₁, λ₂, and λ₃ are respectively balance weights of φ(R̅), φ(L̅), and φ(N).
As described above, R̅ is the expected exposure image. Therefore, a core of the present disclosure is a design of ψ(R̅). Therefore, the present disclosure constructs ψ(R̅) based on illumination prior, and objectivity of a texture and a color (that is, natural image prior). Inspired by the illumination prior, the present disclosure introduces expected illumination in a regularization term; Further, inspired by the natural image prior, the present disclosure keeps a texture and a color consistent with those of the input LLI. However, a difference between illumination of the expected exposure image and the input LLI hinders consistencies of the texture and the color. To resolve this problem, the present disclosure further decouples ψ(R̅) into an illumination regularization term ψ_{I}(R̅), a color regularization term ψ_{c}(R̅), and a texture regularization term ψ_{T}(R̅), that is:

ψ(R̅)=λ_{T}ψ_{T}(R̅)+λ_{C}ψ_{c}(R̅)+λ_{I}ψ_{I}(R̅) (4), where
ψ_{I}(R̅) is designed by using the illumination prior, and ψ_{c} and ψ_{T} are designed based on the natural image prior. In particular, the present disclosure introduces a learnable flexibility factor (namely, a learnable parameter, which is constantly changed in a training iteration process) into ψ_{c} and ψ_{T}, helping ensure consistencies of flexibility of a texture and a color. Therefore, by setting λ₁ to 1, a basic idea of the ZSL enhancer in the present disclosure may be represented as:

$$\overline{R} = arg {m}_{\overline{R}} in {‖ I - ( \overline{R} ∘ \overline{L} + N ) ‖}^{2} + {λ}_{2} φ ( \overline{L} ) + {λ}_{3} ϕ ( N ) + {λ}_{T} {ψ}_{T} ( \overline{R} ) + {λ}_{C} {ψ}_{c} ( \overline{R} ) + {λ}_{I} {ψ}_{I} ( \overline{R} ) \qquad ( 5 )$$

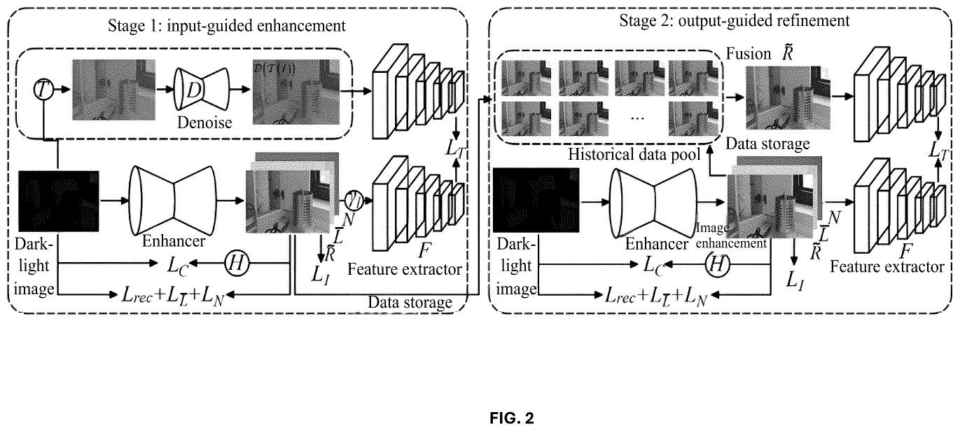

Based on the foregoing analysis, the present disclosure constructs a flexible and controllable ZSL enhancer, which may be referred to as a Zero-shot Enhancer (ZSEer). Refer to FIG. 2. FIG. 2 is a schematic structural diagram of an IEN according to an embodiment of the present disclosure. As shown in FIG. 2, a single LLI is input to a ZSL enhancer (the ZSL enhancer may be a deep neural network (DNN) Enhancer(•)), and then R̅, L̅, and N are output. The ZSL enhancer may be represented as:

R̅,L̅,N=Enhancer(I) (6)

(2) A process of constructing the loss function of the ZSL enhancer may include the following procedure:

The present disclosure establishes a set of loss functions to help reconstruct R̅, L̅, and N. According to formula (5), the present disclosure defines the overall loss function Lₐₗₗ as:

Lₐₗₗ=L_{rec}+λ₂L_{L̅}+λ₃L_{N}+λ_{T}L_{T}+λ_{C}L_{C}+λ_{I}L_{I} (7), where
L_{rec} is a reconstruction loss:

L_{rec}=∥I−(R̅∘L̅+N)∥² ((8), where
L_{L̅} is a regularization loss of the illumination map, and λ₂, λ₃, λ_{T}, λ_{C}, and λ_{I} are respectively set to 0.5, 0.1, 0.2, 1.0, and 0.1. In the present disclosure, a piecewise smoothness constraint is used to define L_{L̅}:

L_{L̅}=∥∇I∘ exp(−λ_{g}∇R̅)∥ (9), where
∇ is a gradient operator, and λ_{g} is a balance factor and is set to 10.
L_{N} is a regularization loss of the output noise map. Herein, the present disclosure does not require prior noise distribution, but simply assumes that an average value of noises is 0. In this case, L_{N} is defined as:

L_{N}=∥M(N)∥ (10), where
M(•) is a function for calculating an input average value.
L_{I}, L_{C}, and L_{T} respectively represent a prior-guided illumination loss, color loss, and texture loss.

The texture loss L_{T} is designed. An objective of the texture loss is to encourage the ZSL enhancer to learn a texture detail from the input LLI. However, low light and high noise of the LLI hinder texture learning. To resolve this problem, in the present disclosure, a light transformation T(•) and a denoising operation D(•) are performed on the input LLI. Specifically, a single LLI I is given, and a transformed image D(T(I)) is first calculated in the present disclosure, and is used as a reference. Then, a perception feature of an enhanced image is constrained to be flexibly consistent with a perception feature of the transformed image, and a formal thereof is described as:

L_{T}=∥F(R̅^{γt})−F(D(T(I)))∥² (11), where

F(•) is a feature extractor (specifically, is a perception feature extractor), and may be implemented by using a pre-trained visual geometry group (VGG) model; and γt is a learnable factor and can reduce an adverse impact of a difference of light between an expected exposure image and a transformed image. The light transformation T(•) may be implemented in multiple manners, such as gamma correction, histogram equalization, and linear stretching. In this embodiment of the present disclosure, gamma correction is simply used, that is, T(I)=I^{γi}, and γi is a learnable parameter. For the denoising operation D(•), a zero-shot denoising operation is used in the present disclosure, and image denoising is implemented in this operation through training by using an input LLI itself.

The color loss L_{C} is designed. Red (r), green (g), and blue (b) components of an enhanced image is constrained by the color loss to be consistent with those components of the input LLI. In addition, inspired by a color measurement method, the present disclosure introduces a color degree regularization term to ensure a color output. A formal definition of L_{C} is:

$${L}_{C} = {\sum }_{i = r , g , b} {‖ M ( H ( {\overline{R}}_{i} ) ) - M ( {I}_{i} ) ‖}^{2} + {λ}_{cf} ‖ {E}_{n} - ( v + ω \times μ ) ‖ \qquad ( 12 )$$

$$where$$

$$μ = \sqrt{{M ( \vert {\overline{R}}_{r} - {\overline{R}}_{g} \vert )}^{2} + {M ( \vert {\overline{R}}_{r} + {\overline{R}}_{g} \vert / 2 - {\overline{R}}_{b} )}^{2}}$$

$$v = \sqrt{{S ( \vert {\overline{R}}_{r} - {\overline{R}}_{g} \vert )}^{2} + {S ( \vert {\overline{R}}_{r} + {\overline{R}}_{g} \vert / 2 - {\overline{R}}_{b} )}^{2}}$$

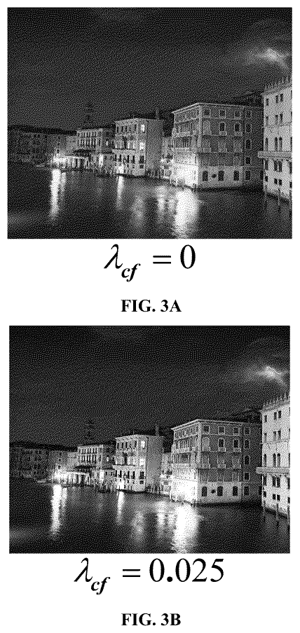

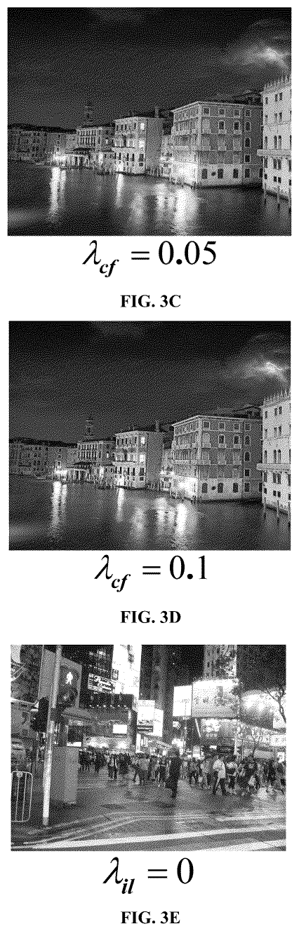

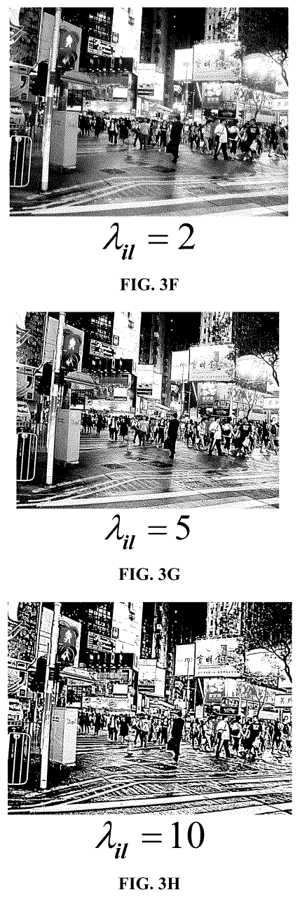

H(R̅ᵢ)=(αR̅ᵢ)^{β} is a pixel-to-pixel conversion function, and adjusts strength of an enhanced image, where both α and β are learnable parameters; M(•) is a function for calculating an input mean, and S(•) is a function for calculating an input variance; R̅ᵢ∈{R̅ᵣ, R̅_{g}, R̅_{b}} are r, 9, and b channels corresponding to R̅, and Iᵢ∈{Iᵣ,I_{g},I_{b}} are r, g, and b channels corresponding to I; and λ_{cf} is a constant parameter used to enhance an image color. Refer to FIGS. 3A-3H. FIGS. 3A-3H are schematic diagrams of analysis of parameters λ_{cf} and λᵢₗ according to an embodiment of the present disclosure. As shown in FIGS. 3A-3H, in the present disclosure, a value of λ_{cf} is 0.025; Eₙ is a constant parameter, determines a color level of an expected enhanced image, and is set to 0.32; and ω is a weight parameter, and is set to 0.3.
The illumination loss L_{I} is designed. The illumination loss constraints illumination of an enhanced image to be close to expected illumination, and improves an image contrast. In this case, the present disclosure defines the illumination loss by using a global constraint and a local constraint. Desired light ε is given, and L_{I} may be defined as:

$${L}_{I} = ‖ M ( \overline{R} ) - ε ‖ - {λ}_{il} {\sum }_{i = 1}^{B} S ( {δ}^{i} ( \overline{R} ) ) \qquad ( 13 )$$

δ(•) is an operation of generating a local image from an input image. B is a quantity of local image blocks. λᵢₗ is a parameter used to balance a local contrast of the expected exposure image, and as shown in FIGS. 3A-3H, is set to 2 in this embodiment of the present disclosure according to experience. ε is a constant parameter, and is usually set in a range of [0.25, 0.75], which helps the ZSL enhancer overcome subjectivity of a definition of normal illumination.
(3) A process of training the ZSL enhancer by iteratively optimizing the loss function of the ZSL enhancer may include the following procedure:
In this embodiment of the present disclosure, seven datasets are used for a comparative experiment: a real low-light (LOL-real) dataset, a test low-light (LOL-test) dataset, a multi-exposure image fusion (MEF) dataset, a low-light image enhancement dataset (LIME-D), a digital image contrast enhancement dataset (DICM), a commonly used low-light enhancement test set (for example, Vasileios Vonikakis (VV) dataset), and a naturalness preserved enhancement (NPE) dataset. LOL-real and LOL-test have normal-light images paired with LLIs. Therefore, in the present disclosure, a peak signal-to-noise ratio (PSNR), a structural similarity (SSIM), and a natural image quality evaluator (NIQE) are used for evaluation. MEF, LIME-D DICM, VV, and NPE do not have normal-light images paired with LLIs. Therefore, in the present disclosure, a non-reference indicator NIQE is used for evaluation. Comparison methods include: a low-light image enhancement method (LIME), an LLIE method using the camera response model (LECARM), a retinex network (Retinex-Net), KinD++, an SNR perception LLIE method (Xu et al.), a UEGAN, an enlighten generative adversarial network (GAN), an EnlightenGAN, an unsupervised night enhancement method (Jin et al.), a self-calibrated illumination (SCI) method, a semantic-guided zero-shot learning (SGZ) method, Zero-DCE++, RetinexDIP, and a self-supervised method based on a difference untrained network (Liang et al.).
In an actual enhancement application, to further reduce an adverse impact of a difference between light of the expected exposure image and an input single LLI, as shown in FIG. 2, in the present disclosure, an enhancer is trained by using a two-stage progressive learning policy, namely, input-guided enhancement and output-guided refinement.
A first stage of training is performed on the ZSL enhancer in a manner of input-guided enhancement: obtaining a single LLI used for iterative training; and inputting the single LLI used for iterative training into the ZSL enhancer to obtain a corresponding expected exposure image; and
a second stage of training is performed on the ZSL enhancer in a manner of output-guided refinement:
storing, in a historical data pool, an expected exposure image obtained through each iterative training in the first stage, and using, as a rough enhanced exposure image output in the first stage, an average value of multiple expected exposure images stored closest to a current moment in the historical data pool; inputting the rough enhanced exposure image into the ZSL enhancer to obtain a corresponding expected exposure image; and storing, in the historical data pool, expected exposure images obtained through each iterative training in the second stage.
Specifically, the input-guided enhancement means that an input LLI is used to guide learning of the expected exposure image. At this stage, a texture loss needs to be flexibly constrained due to impacts of low illumination and noise amplification. In addition, to stabilize a training process, the historical data pool is constructed to store expected exposure images output in each iteration. The present disclosure then constructs an output of the first stage using an average of 200 latest expected exposure images. After this stage, the network outputs a rough enhanced exposure image \tilde{R}.
Output-guided refinement means that the rough enhanced exposure image \tilde{R} in the first stage and historical enhanced image refinement are used to restore the expected exposure image. At this stage, the texture loss is modified as follows:

L_{T}=∥F(R̅)−F(\tilde{R})∥² (14)

Herein, the flexibility factor γt is removed because appropriate illumination is learned in the first stage, and the difference between the illumination of \tilde{R} and a final expected exposure image is relatively small. Note that the output-guided refinement stage may be performed multiple times. In each execution, a latest expected exposure image is used to update \tilde{R}.

In this case, a two-stage progressive learning scheme is designed in the present disclosure, which uses an input LLI and a historical expected exposure image to gradually restore an ideal image, and helps the enhancer to generate an image with a clear texture and a bright color.

S30. Obtain an expected exposure image output by the IEN with respect to the to-be-processed single LLI.

In this embodiment of the present disclosure, the expected exposure image corresponding to the to-be-processed single LLI may be obtained based on the IEN.

In addition, to verify an effect of the image enhancement method provided in this embodiment of the present disclosure, the following experimental analysis is performed. In the present disclosure, three versions of ZSL enhancers are established based on different expected light standards, and it indicates that the established ZSL enhancers can achieve competitiveness and visibility compared to existing methods:

In the present disclosure, performance of the proposed method is compared with that of several state-of-the-art image enhancement methods. In this embodiment of the present disclosure, three versions of ZSL enhancers are established. ZSEer-V1 is a first version of the enhancer, and fixed desired illumination of 0.5 is configured. ZSEer-V2 is a second version of the enhancer, 10 expected illumination levels are configured, and a final result is determined by a non-reference indicator. ZSEer-V3 is a third version of the enhancer, 10 expected illumination levels are configured, and a final result is determined by a subjective evaluation of a user interaction.

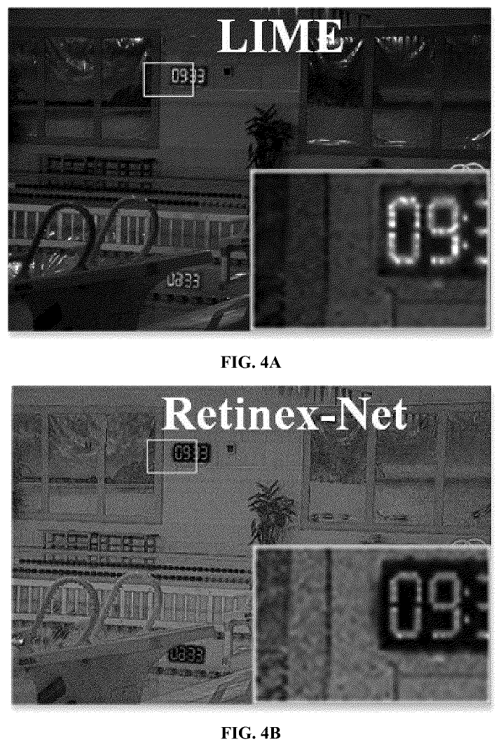

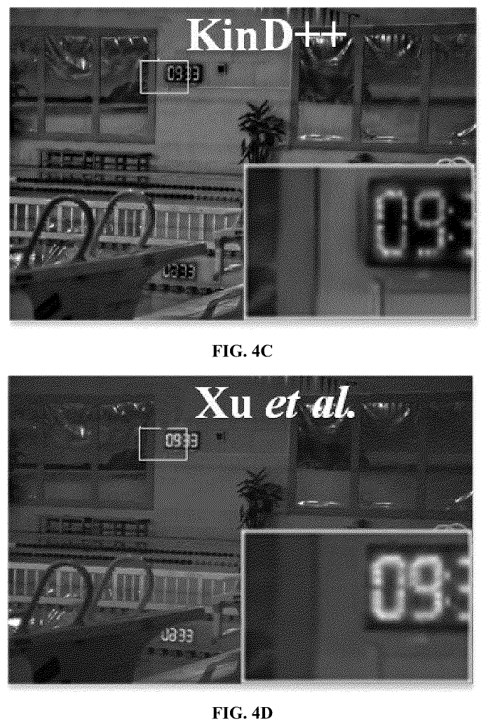

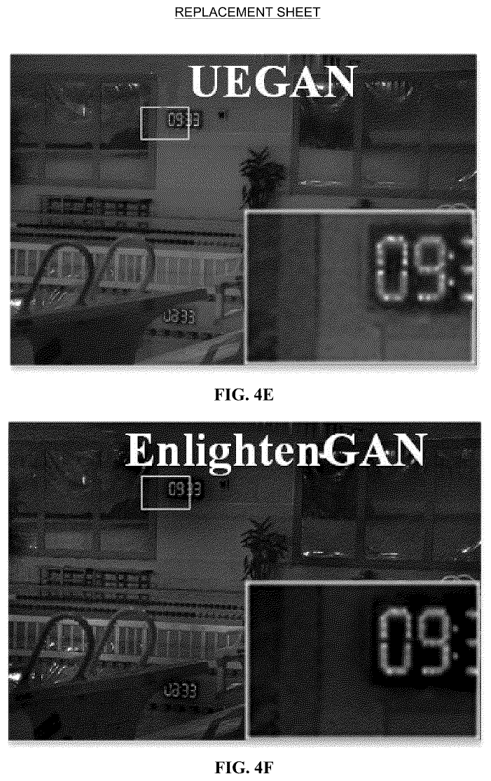

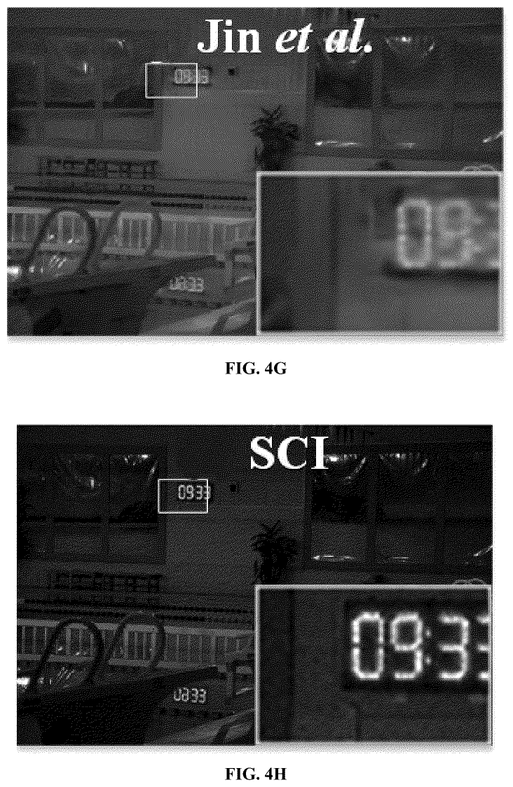

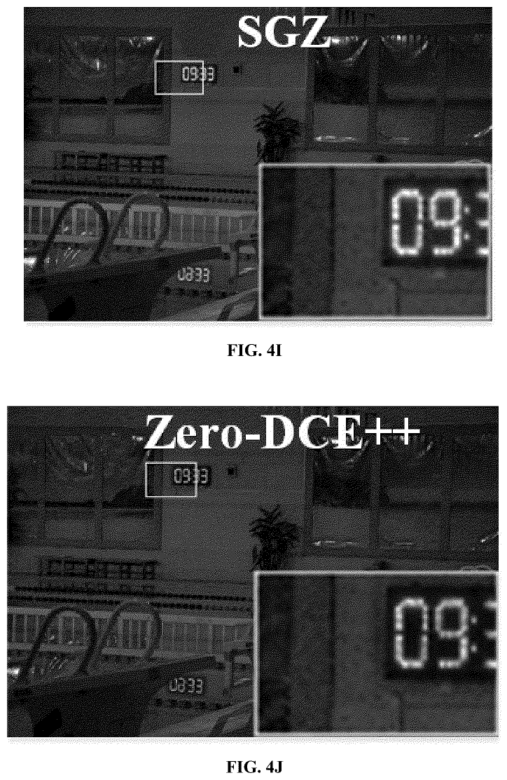

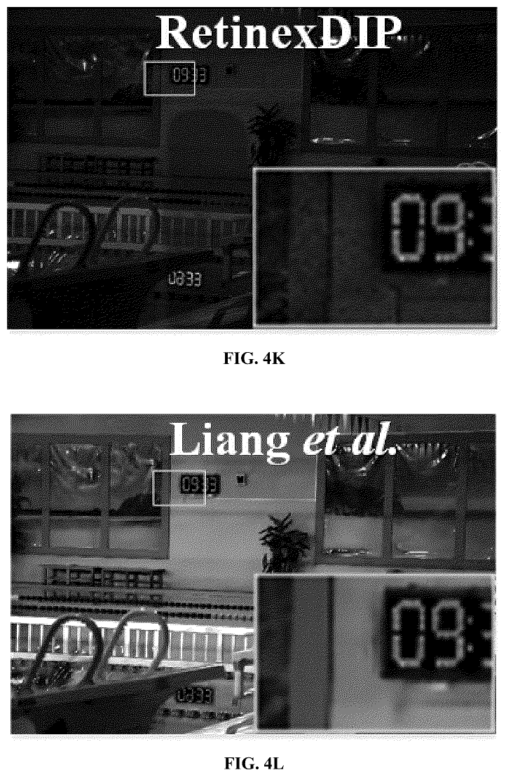

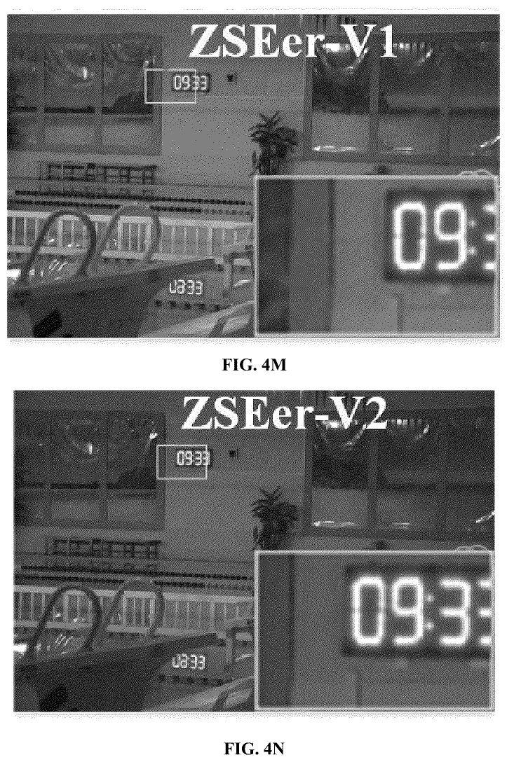

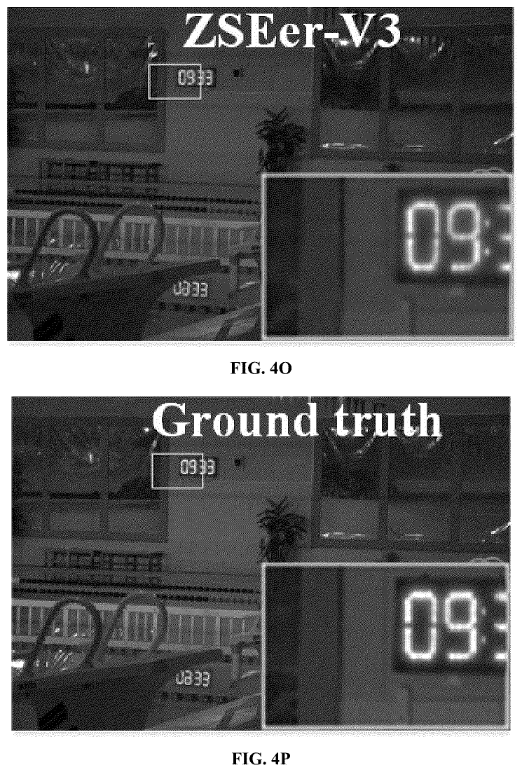

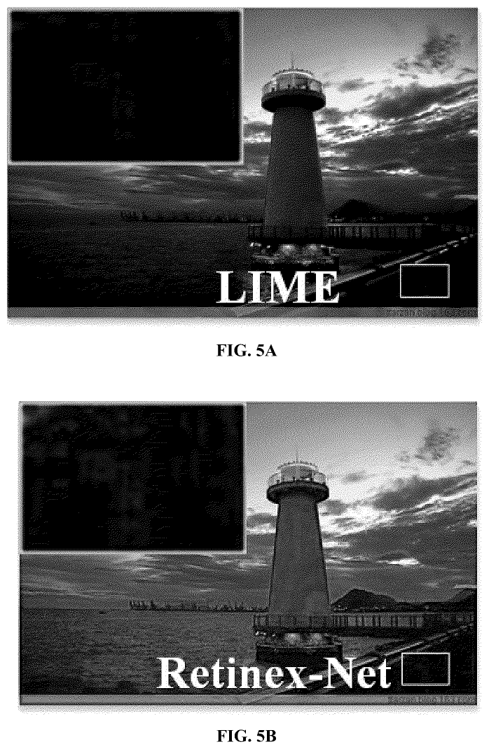

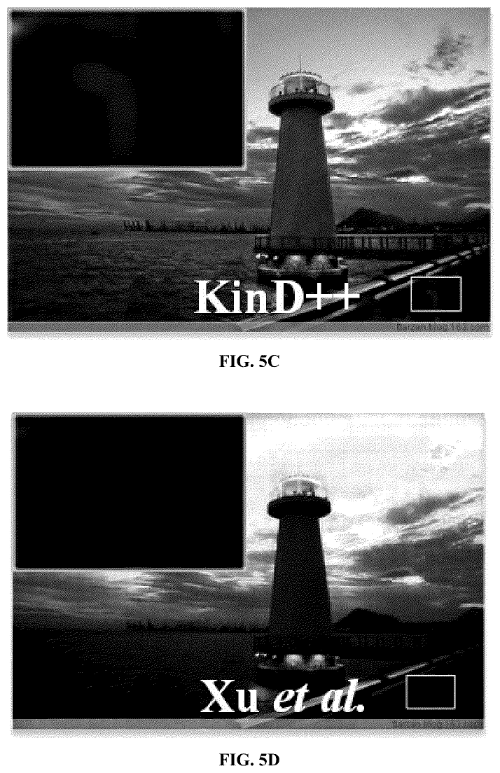

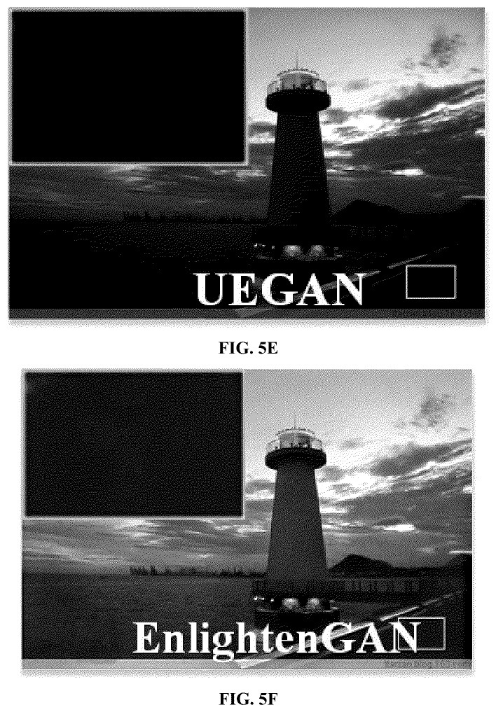

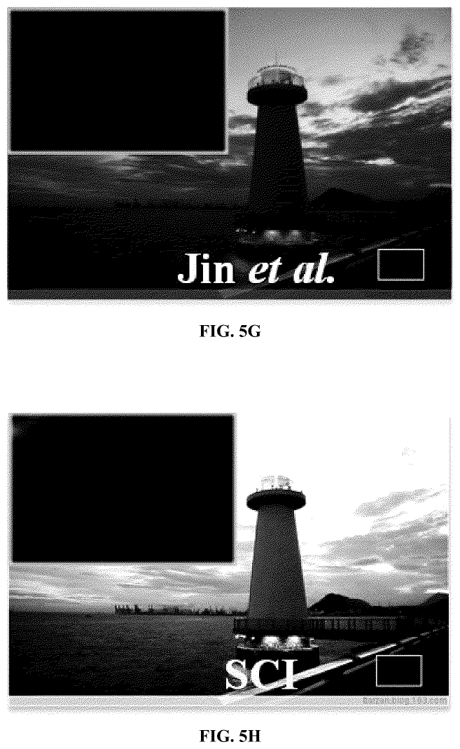

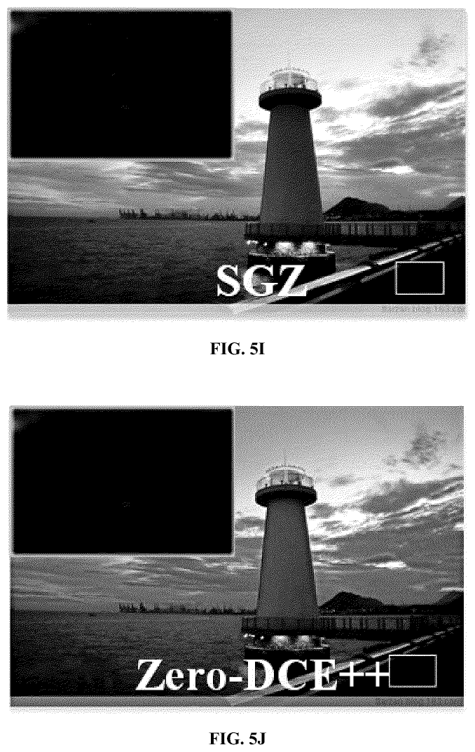

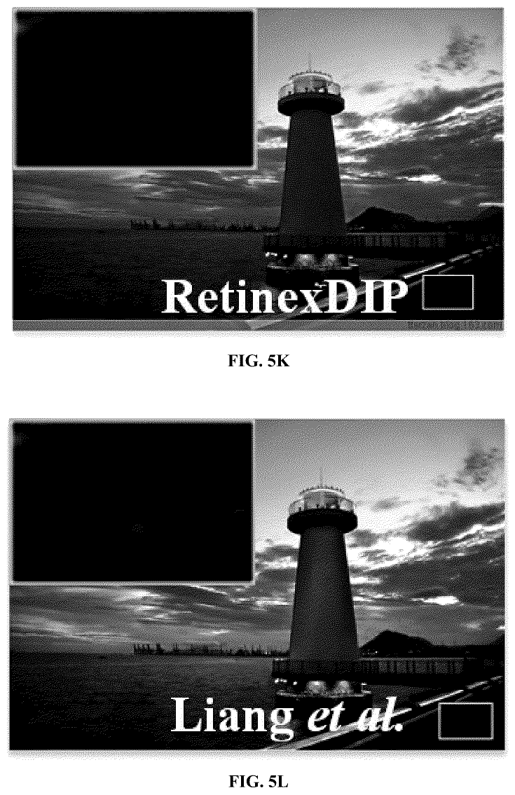

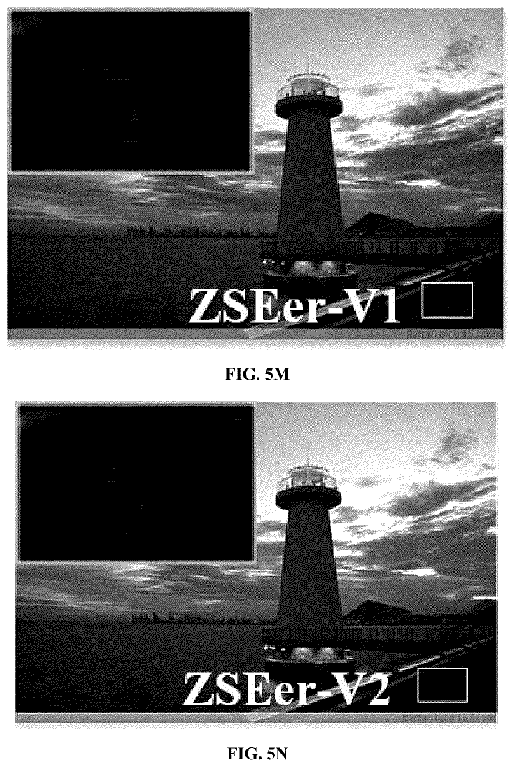

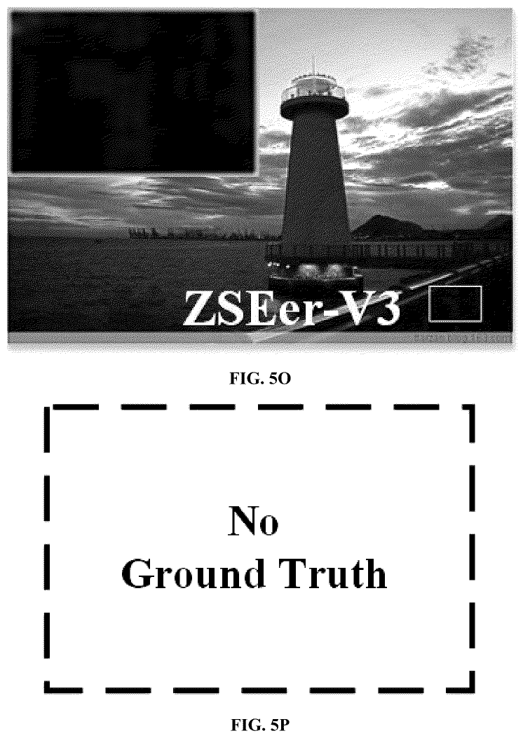

Results of the LOL-real dataset and the LOL-test dataset. Refer to Table 1. Table 1 is results of an LOL-real dataset and an LOL-test dataset. As shown in Table 1, compared with a non-learning method, the proposed method performs better on the PSNR, the SSIM, and the NIQE. Appropriate expected light is given, and ZSEer-V3 can even achieve performance comparable to that of the SL method and the unsupervised learning method. Compared with a method using only LLI for training, even if no user interaction is required, the proposed method can obtain more competitive performance. These results can be attributed to the introduction of expected lighting and proposed regularization losses that can reduce the discomfort of image reconstruction. In addition, refer to FIGS. 4A-4P and FIGS. 5A-5P. FIGS. 4A-4P and FIGS. 5A-5P show a result of a visualization comparison between an IEN according to an embodiment of the present disclosure and another LLIE model. As shown in FIGS. 4A-4P and FIGS. 5A-5P, an existing method is easy to amplify a noise and a color is excessively enhanced. In contrast, the proposed method can effectively suppress a noise and maintain image naturalness. In addition, ZSEer-V3 significantly improves the PSNR and the SSIM, but has a similar NIQE to that of ZSEer-V1 and ZSEerV2. The result is because ZSEer-V1, ZSEer-V2, and ZSEer-V3 restore similar textures and colors.

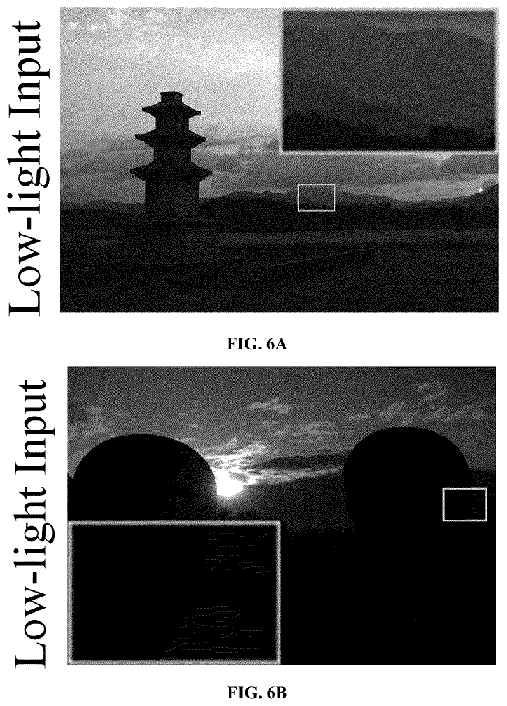

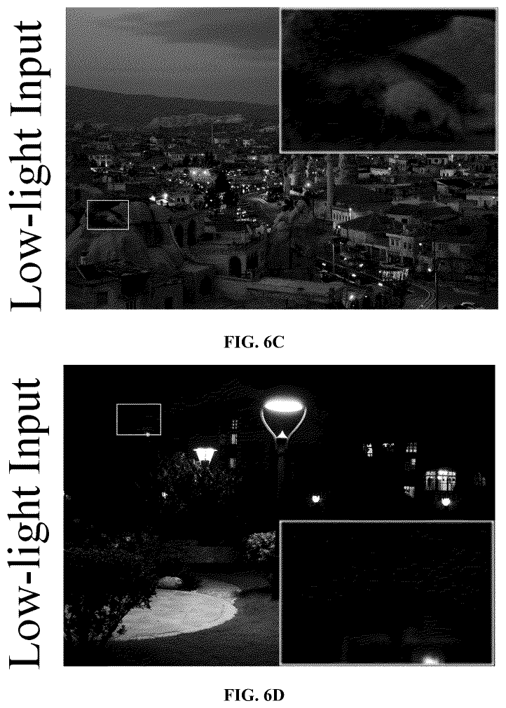

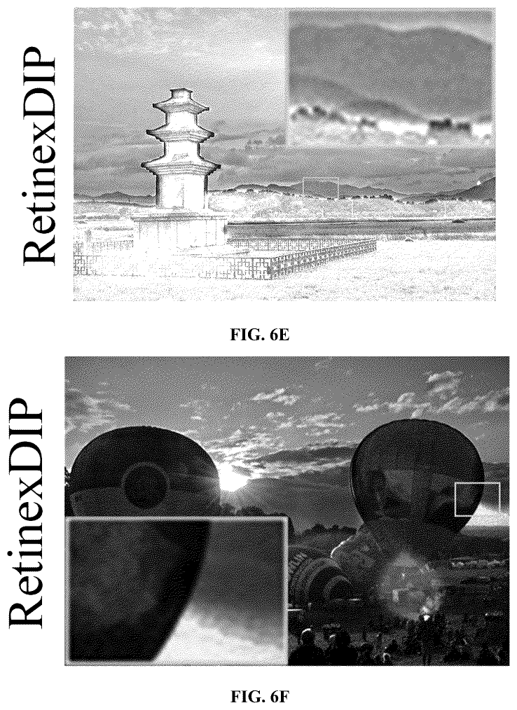

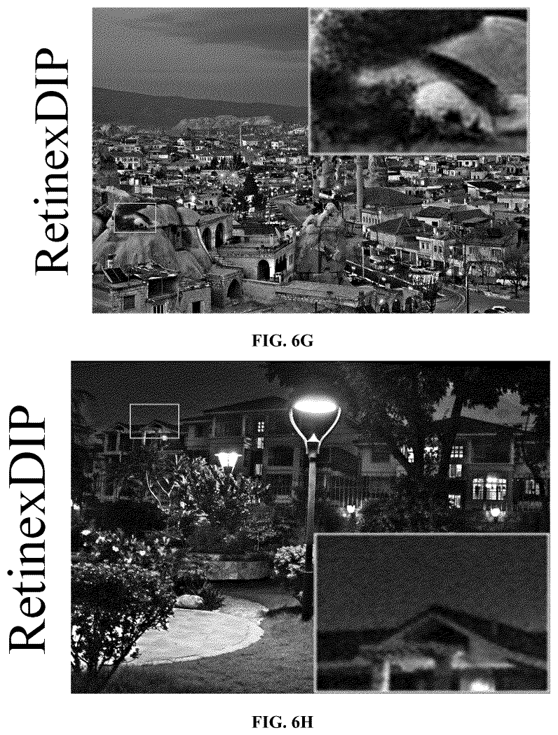

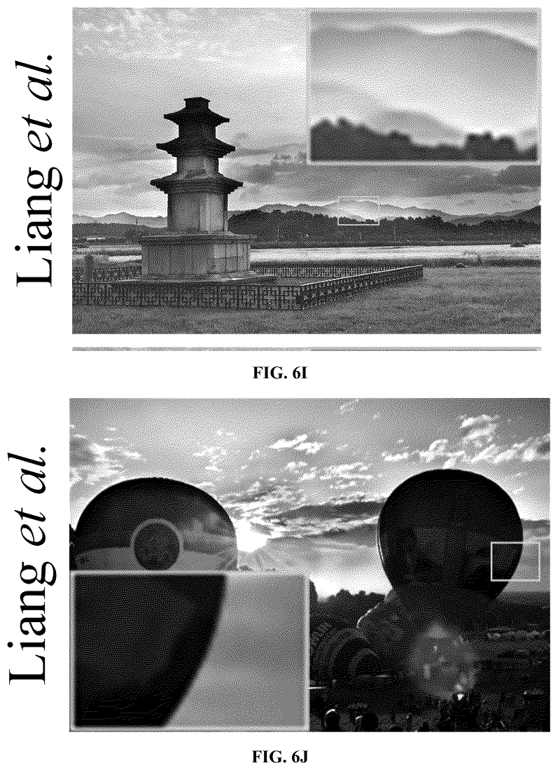

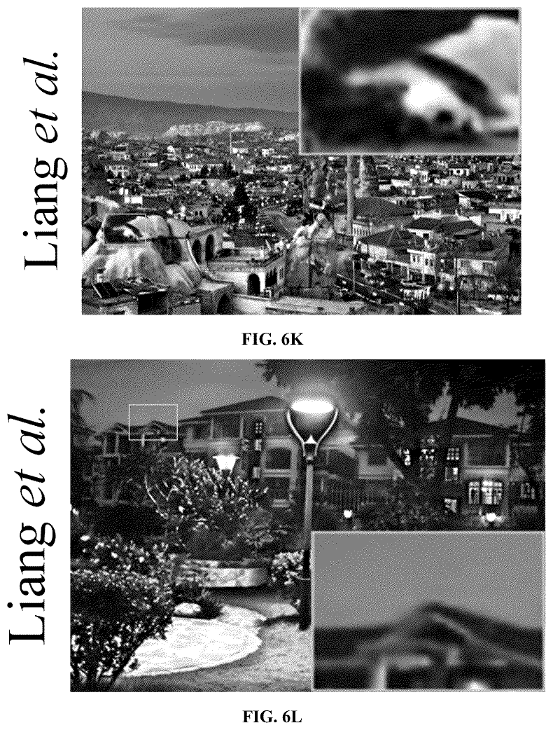

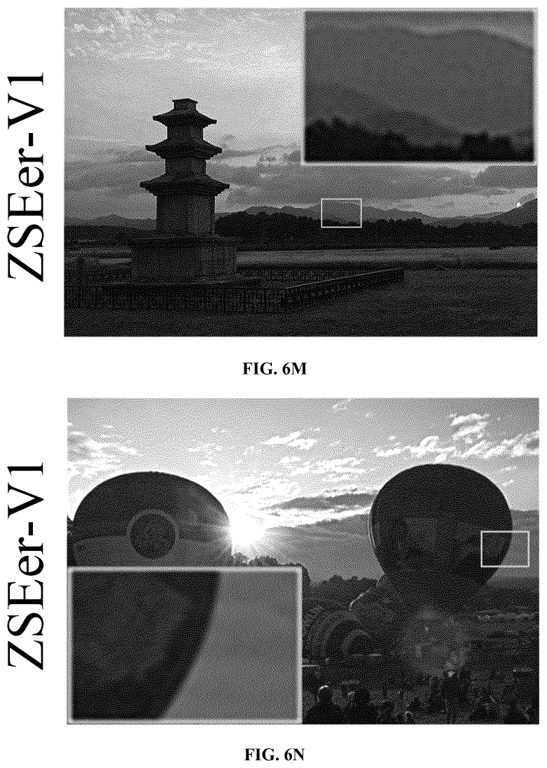

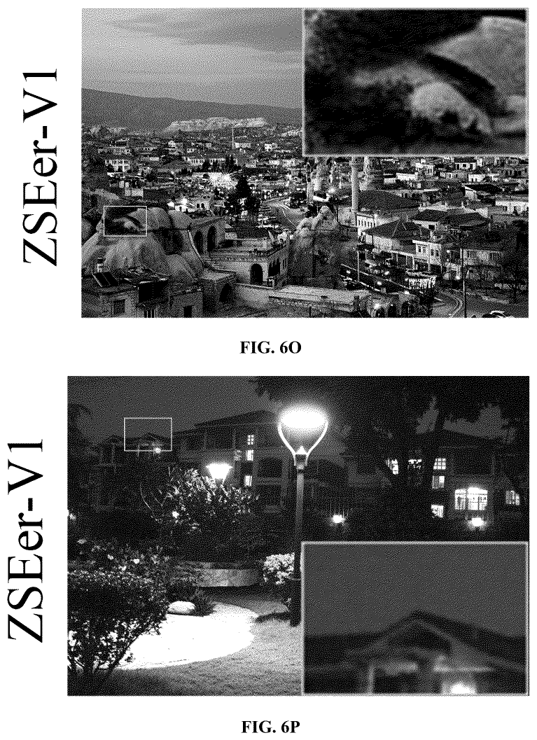

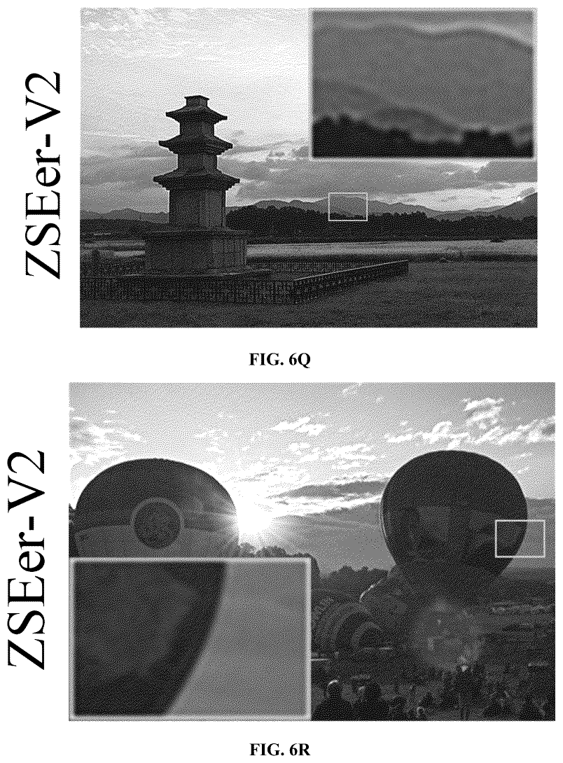

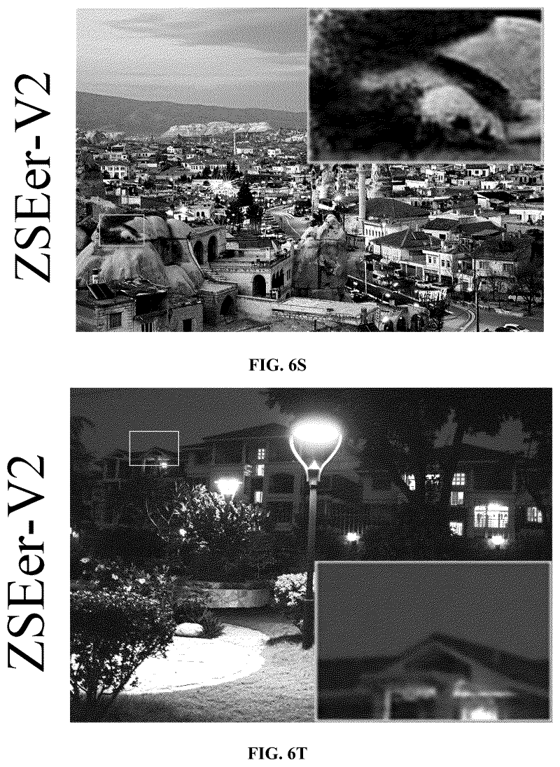

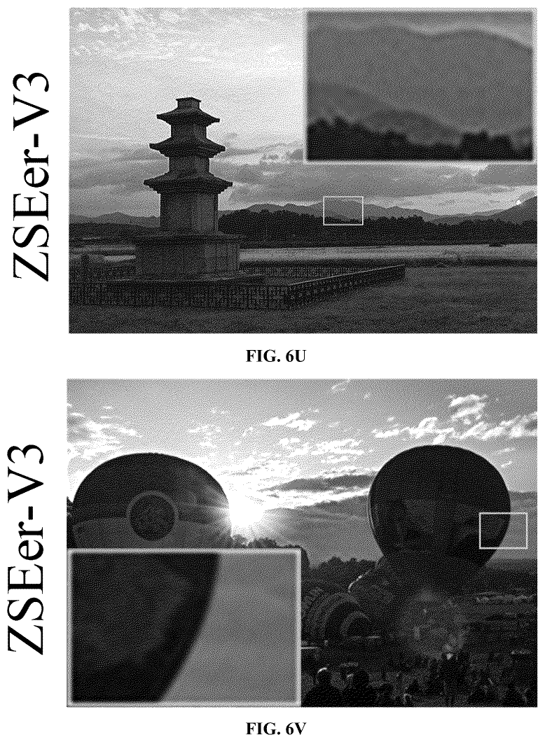

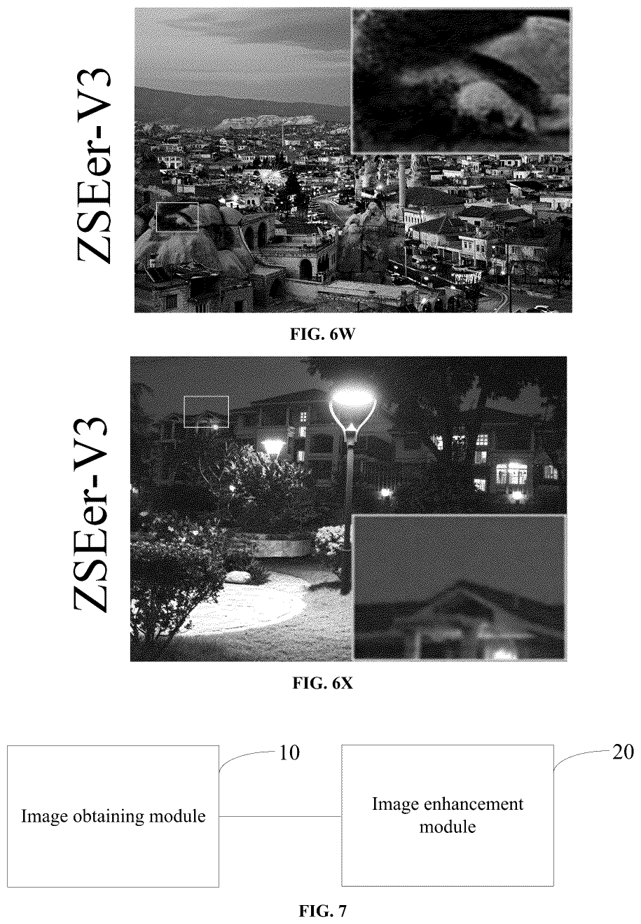

Generality evaluation of a non-reference real dataset. In the present disclosure, an LLIE model in a real scene is further evaluated by using the MEF, LIME-D, DICM, VV, and NPE datasets. Refer to Table 2. Table 2 is an NIQE result of a non-reference dataset. It may be seen by comparing Table 1 and Table 2 that although the SL method and the unsupervised learning method obtain very competitive results on the LOL-real and LOL-test datasets, satisfactory performance cannot be achieved in some real scenes. This result is because a data distribution of a test image may be quite different from a data distribution of a training image. In contrast, this method does not depend on training data, which enables this method to be well generalized to an unknown scene. In addition, compared with the method that uses a single LLI for training, the method proposed in the present disclosure can obtain more competitive visibility. Refer to FIGS. 6A-6X. FIGS. 6A-6X show a result of a visibility comparison between an TEN according to an embodiment of the present disclosure and another LLIE model on a non-reference dataset.

TABLE 1

| Learning | | | LOL-real | | | LOL-test | | |
|---|---|---|---|---|---|---|---|---|
| mode | Dataset | Method | PSNR | SSIM | NIQE | PSNR | SSIM | NIQE |
| Non-learning | Single | LIME | 17.14 | 0.5373 | 8.270 | 16.59 | 0.5209 | 8.058 |
| | LLI | LECARM | 17.56 | 0.5648 | 8.044 | 14.41 | 0.5449 | 7.843 |
| SL | Multiple | Retinex-Net | 16.10 | 0.4071 | 8.044 | 16.77 | 0.4250 | 8.879 |
| | paired | KinD++ | 22.21 | 0.8379 | 8.044 | 21.30 | 0.8226 | 5.118 |
| | LLIs | Xu et al. | 21.48 | 0.8489 | 4.623 | 24.61 | 0.8418 | 4.976 |
| Unsupervised | Multiple | UEGAN | 21.19 | 0.7103 | 6.655 | 17.09 | 0.6664 | 6.578 |
| learning | non- | EnlightenGAN | 18.64 | 0.6767 | 5.089 | 17.48 | 0.6515 | 4.684 |
| | paired | Jin et al. | 25.51 | 0.7830 | 4.314 | 21.52 | 0.7629 | 4.492 |
| | LLIs | | | | | | | |
| | Multiple | SCI | 17.31 | 0.5397 | 8.046 | 13.51 | 0.5068 | 7.678 |
| | LLIs | SGZ | 18.58 | 0.5842 | 8.072 | 16.04 | 0.5763 | 7.823 |
| | | Zero-DCE++ | 18.06 | 0.5795 | 8.057 | 14.86 | 0.5624 | 7.767 |
| Zero-shot | Single | RetinexDIP | 11.67 | 0.3666 | 7.285 | 9.16 | 0.3221 | 7.035 |
| unsupervised | LLI | Liang et al. | 18.58 | 0.5842 | 4.712 | 16.50 | 0.7268 | 4.673 |
| learning | | ZSEer-V1 | 17.32 | 0.7647 | 4.972 | 18.36 | 0.7651 | 4.804 |
| | | ZSEer-V2 | 16.79 | 0.7415 | 4.601 | 17.82 | 0.7586 | 4.587 |
| | | ZSEer-V3 | 24.33 | 0.8219 | 4.806 | 23.03 | 0.8038 | 4.625 |

TABLE 2

| Method | MEF | LIME-D | DICM | VV | NPE | Average |
|---|---|---|---|---|---|---|
| LIME | 3.285 | 3.837 | 3.465 | 2.548 | 3.663 | 3.360 |
| LECARM | 3.323 | 3.912 | 3.413 | 2.628 | 4.012 | 3.458 |
| Retinex-Net | 4.374 | 4.591 | 4.523 | 2.701 | 4.467 | 4.131 |
| KinD++ | 3.737 | 4.740 | 3.196 | 2.686 | 3.717 | 3.615 |
| Xu et al. | 3.983 | 5.123 | 4.259 | 5.812 | 4.568 | 4.749 |
| UEGAN | 3.666 | 3.979 | 3.513 | 3.117 | 3.553 | 3.566 |
| EnlightenGAN | 3.199 | 3.655 | 3.546 | 2.536 | 3.657 | 3.319 |
| Jin et al. | 3.895 | 5.409 | 4.704 | 9.572 | 5.530 | 5.822 |
| SCI | 3.701 | 4.256 | 3.648 | 2.932 | 4.113 | 3.730 |
| SGZ | 3.360 | 3.956 | 3.342 | 2.835 | 3.487 | 3.396 |
| Zero-DCE++ | 3.281 | 3.769 | 3.562 | 3.211 | 3.581 | 3.481 |
| RetinexDIP | 3.236 | 3.797 | 3.393 | 2.478 | 3.599 | 3.301 |
| Liang et al | 4.278 | 5.533 | 4.287 | 9.221 | 5.212 | 5.706 |
| ZSEer-V1 | 3.774 | 4.352 | 3.871 | 2.839 | 3.602 | 3.688 |
| ZSEer-V2 | 3.247 | 3.831 | 3.367 | 2.670 | 3.301 | 3.283 |
| ZSEer-V3 | 3.375 | 3.914 | 3.398 | 2.702 | 3.511 | 3.380 |

Based on the image enhancement method provided in the foregoing embodiment, an embodiment of the present disclosure correspondingly provides an apparatus for performing the foregoing image enhancement method. A schematic structural diagram of the apparatus is shown in FIG. 7, including:
an image obtaining module 10 configured to obtain a to-be-processed single LLI; and
an image enhancement module 20 configured to input the to-be-processed single LLI into an IEN, where the IEN is obtained by training a ZSL enhancer by defining a prior-guided regularization loss; and obtain an expected exposure image output by the IEN with respect to the to-be-processed single LLI.

Optionally, a process of training, by the image enhancement module 20, the ZSL enhancer by defining the prior-guided regularization loss to obtain the IEN includes:
constructing the ZSL enhancer:

$$\overline{R} = arg {m}_{\overline{R}} in {‖ I - ( \overline{R} ∘ \overline{L} - N ) ‖}^{2} + {λ}_{1} ψ ( \overline{R} ) + {λ}_{2} φ ( \overline{L} ) + {λ}_{3} ϕ ( N ) ,$$

where
ψ(R̅)=λ_{T}ψ_{T}(R̅)+λ_{C}ψ_{c}(R̅)+λ_{I}ψ_{I}(R̅); R̅ is the output expected exposure image; L̅ is an output illumination ratio map (IRM), and meets a piecewise smoothness constraint, L̅=L/\tilde{L}, L is an illumination map, and \tilde{L} is desired illumination; I is an input single LLI, R̅=R∘\tilde{L}, and R is a reflectance map; N is an output noise map; ψ(R̅), φ(L̅), and φ(N) are respectively regularization terms of the output expected exposure image, the output IRM, and the output noise map; λ₁, λ₂, and λ₃ are respectively balance weights of ψ(R̅), φ(L̅), and φ(N), λ₁ is set to 1, λ₂ is set to 0.5, and λ₃ is set to 0.1; and ψ_{T}(R̅), ψ_{c}(R̅), and ψ_{I}(R̅) are respectively a texture regularization term, a color regularization term, and an illumination regularization term; constructing a loss function of the ZSL enhancer:

Lₐₗₗ=L_{rec}+λ₂L_{L̅}+λ₃L_{N}+λ_{T}L_{T}+λ_{C}L_{C}+λ_{I}L_{I}, where
Lₐₗₗ is an overall loss function; L_{rec} is a reconstruction loss, and L_{rec}=∥I−(R̅∘L̅+N)∥²; L_{L̅} is a regularization loss of the illumination map, L_{L̅}=∥∇I∘ exp(−λ_{g}∇R̅)∥, ∇ is a gradient operator, λ_{g} is a balance factor, and λ_{g} is set to 10; L_{N} is a regularization loss of the output noise map, L_{N}=∥M(N)∥, and M(•) is a function for calculating an input mean; L_{T} is a texture loss, L_{T}=∥F(R̅^{γt})−F(D(T(I)))∥², F(•) is a feature extractor, T(•) is a light transformation, D(•) is a denoising operation, and γt is a learnable factor; L_{C} is a color loss,

$${L}_{C} = , {\sum }_{i = r , g , b} {‖ M ( H ( {\overline{R}}_{i} ) ) - M ( {I}_{i} ) ‖}^{2} + {λ}_{cf} ‖ {E}_{n} - ( v + ω \times μ ) ‖ ,$$

$$μ = \sqrt{{M ( \vert {\overline{R}}_{r} - {\overline{R}}_{g} \vert )}^{2} + {M ( \vert {\overline{R}}_{r} + {\overline{R}}_{g} \vert / 2 - {\overline{R}}_{b} )}^{2}} ,$$

$$v = \sqrt{{S ( \vert {\overline{R}}_{r} - {\overline{R}}_{g} \vert )}^{2} + {S ( \vert {\overline{R}}_{r} + {\overline{R}}_{g} \vert / 2 - {\overline{R}}_{b} )}^{2}} ,$$

H(R̅ᵢ)=(αR̅ᵢ)^{β} is a pixel-to-pixel conversion function, α and β are learnable parameters, and S(•) is a function for calculating an input variance; R̅ᵢ∈{R̅ᵣ,R̅_{g},R̅_{b}} are r, g, and b channels corresponding to R̅, and Iᵢ∈{Iᵣ,I_{g},I_{b}} are r, g, and b channels corresponding to I; λ_{cf} is a constant parameter used to enhance an image color, and is set to 0.025; Eₙ is a constant parameter used to determine a color level of an image, and is set to 0.32; ω is a weight parameter, and is set to 0.3; and
L_{I} is an illumination loss,

$${L}_{I} = ‖ M ( \overline{R} ) - ε ‖ - {λ}_{i l} {\sum }_{i = 1}^{B} S ( {δ}^{i} ( \overline{R} ) ) ,$$

δ(•) is an illumination loss, is an operation of generating a local image from an input image, B is a quantity of image blocks, λᵢₗ is a parameter used to balance a local contrast of the expected exposure image, and λᵢₗ is set to 2; and ε is a constant parameter set in a range of [0.25, 0.75]; and
training the ZSL enhancer by iteratively optimizing the loss function of the ZSL enhancer, and using the trained ZSL enhancer as the IEN.

Optionally, a process of training, by the image enhancement module 20, the ZSL enhancer includes:
performing a first stage of training on the ZSL enhancer in a manner of input-guided enhancement: obtaining a single LLI used for iterative training; and inputting the single LLI used for iterative training into the ZSL enhancer to obtain a corresponding expected exposure image; and
performing a second stage of training on the ZSL enhancer in a manner of output-guided refinement:
storing, in a historical data pool, an expected exposure image obtained through each iterative training in the first stage, and using, as a rough enhanced exposure image output in the first stage, an average value of multiple expected exposure images stored closest to a current moment in the historical data pool; inputting the rough enhanced exposure image into the ZSL enhancer to obtain a corresponding expected exposure image; and storing, in the historical data pool, expected exposure images obtained through each iterative training in the second stage.
Optionally, the light transformation T(•) is gamma correction, and the denoising operation D(•) is a zero-shot denoising operation.
It should be noted that for a detailed function of each module in this embodiment of the present disclosure, reference may be made to a corresponding public part of the foregoing image enhancement method embodiment. Details are not described herein again.
Based on the image enhancement method provided in the foregoing embodiment, an embodiment of the present disclosure provides an electronic device, and the electronic device includes at least one memory and at least one processor. The memory stores an application program, the processor invokes the application program stored in the memory, and the application program is used to implement the image enhancement method.
Based on the image enhancement method provided in the foregoing embodiment, an embodiment of the present disclosure provides a storage medium, the storage medium stores computer program code, and the image enhancement method is implemented when the computer program code is executed.
The image enhancement method and apparatus, the electronic device, and the storage medium provided in the present disclosure are described above in detail. Specific examples are used herein for illustration of the principles and implementations of the present disclosure. The description of the foregoing embodiments is used to help understand the method of the present disclosure and the core principles thereof. In addition, those of ordinary skill in the art can make various modifications in terms of specific implementations and scope of application in accordance with the ideas of the present disclosure. In conclusion, the content of this specification shall not be construed as limitations to the present disclosure.
It should be noted that, the embodiments in the description are described in a progressive manner. Each embodiment focuses on the difference from other embodiments, and the same and similar parts between the embodiments may refer to each other. Since the apparatus disclosed in an embodiment corresponds to the method disclosed in an embodiment, the description is relatively simple, and for related content, references can be made to the description of the method.
It should be further noted that, in this description, relationship terms such as first and second are only used to distinguish an entity or operation from another entity or operation, but do not necessarily require or imply that there is any actual relationship or order between these entities or operations. In addition, terms “include”, “comprise”, or their any other variations are intended to cover a non-exclusive inclusion, so that a process, a method, an article, or a device including a series of elements includes inherent elements, or also includes inherent elements of the process, the method, the article, or the device. Without more restrictions, the elements defined by the sentence “including a . . . ” do not exclude the existence of other identical elements in a process, method, article, or device including the elements.
The above description of the disclosed embodiments enables those skilled in the art to achieve or use the present disclosure. Various modifications to these embodiments are readily apparent to those skilled in the art, and the generic principles defined herein may be practiced in other embodiments without departing from the spirit or scope of the present disclosure. Thus, the present disclosure is not limited to the embodiments shown herein but falls within the widest scope consistent with the principles and novel features disclosed herein.

1. An image enhancement method, wherein the method comprises:
obtaining a to-be-processed single low-light image (LLI);
inputting the to-be-processed single LLI into an image enhancement network (IEN), wherein the IEN is obtained by training a zero-shot learning (ZSL) enhancer by defining a prior-guided regularization loss; and
obtaining an expected exposure image output by the IEN with respect to the to-be-processed single LLI.

2. The method according to claim 1, wherein a process of training the ZSL enhancer by defining the prior-guided regularization loss to obtain the IEN comprises:
constructing the ZSL enhancer:
$$\overline{R} = {arg min}_{\overline{R}} {‖ I - ( \overline{R} ∘ \overline{L} + N ) ‖}^{2} + {λ}_{1} ψ ( \overline{R} ) + {λ}_{2} φ ( \overline{L} ) + {A}_{3} ϕ ( N ) ,$$
wherein
ψ(R̅)=λ_{T}ψ_{T}(R̅)+λ_{C}ψ_{c}(R̅)+λ_{I}ψ_{I}(R̅); R̅ is the output expected exposure image; L̅ is an output illumination ratio map (IRM), and meets a piecewise smoothness constraint, L̅=L/\tilde{L}, L is an illumination map, and \tilde{L} is desired illumination; I is an input single LLI, R̅=R∘\tilde{L}, and R is a reflectance map; N is an output noise map; ψ(R̅), φ(L̅), and φ(N) are respectively regularization terms of the output expected exposure image, the output IRM, and the output noise map; λ₁, λ₂, and λ₃ are respectively balance weights of ψ(R̅), φ(L̅), and φ(N), λ₁ is set to 1, λ₂ is set to 0.5, and λ₃ is set to 0.1; and ψ_{T}(R̅), ψ_{c}(R̅), and ψ_{I}(R̅) are respectively a texture regularization term, a color regularization term, and an illumination regularization term;
constructing a loss function of the ZSL enhancer:
Lₐₗₗ=L_{rec}+λ₂L_{L̅}+λ₃L_{N}+λ_{T}L_{T}+λ_{C}L_{C}+λ_{I}L_{I}, wherein
Lₐₗₗ is an overall loss function; L_{rec} is a reconstruction loss, and L_{rec}=∥I−(R̅∘L̅+N)∥²; L_{L̅} is a regularization loss of the illumination map, L_{L̅}=∥∇I∘ exp(−λ_{g}∇R̅)∥, ∇ is a gradient operator, λ_{g} is a balance factor, and λ_{g} is set to 10; L_{N} is a regularization loss of the output noise map, L_{N}=∥M(N)∥, and M(•) is a function for calculating an input mean; L_{T} is a texture loss, L_{T}=∥F(R̅^{γt})−F(D(T(I)))∥², F(•) is a feature extractor, T(•) is a light transformation, D(•) is a denoising operation, and γt is a learnable factor; L_{C} is a color loss,
$${L}_{C} = , {\sum }_{i = r , g , b} {‖ M ( H ( {\overline{R}}_{i} ) ) - M ( {I}_{i} ) ‖}^{2} + {λ}_{cf} ‖ {E}_{n} - ( v + ω \times μ ) ‖ ,$$
$$μ = \sqrt{{M ( \vert {\overline{R}}_{r} - {\overline{R}}_{g} \vert )}^{2} + {M ( \vert {\overline{R}}_{r} + {\overline{R}}_{g} \vert / 2 - {\overline{R}}_{b} )}^{2}} ,$$
$$v = \sqrt{{S ( \vert {\overline{R}}_{r} - {\overline{R}}_{g} \vert )}^{2} + {S ( \vert {\overline{R}}_{r} + {\overline{R}}_{g} \vert / 2 - {\overline{R}}_{b} )}^{2}} ,$$
H(R̅ᵢ)=(αR̅ᵢ)^{β} is a pixel-to-pixel conversion function, α and β are learnable parameters, and S(•) is a function for calculating an input variance; R̅ᵢ∈{R̅ᵣ,R̅_{g},R̅_{b}} are r, g, and b channels corresponding to R̅, and Iᵢ∈{Iᵣ,I_{g},I_{b}} are r, g, and b channels corresponding to I; λ_{cf} is a constant parameter used to enhance an image color, and is set to 0.025; Eₙ is a constant parameter used to determine a color level of an image, and is set to 0.32; ω is a weight parameter, and is set to 0.3; L_{I} is an illumination loss,
$${L}_{I} = ‖ M ( \overline{R} ) - ε ‖ - {λ}_{l} {\sum }_{i = 1}^{B} S ( {δ}^{′} ( \overline{R} ) ) ,$$
δ(•) is an operation of generating a local image from an input image, B is a quantity of image blocks, λᵢₗ is a parameter used to balance a local contrast of the expected exposure image, and λᵢₗ is set to 2; and ε is a constant parameter set in a range of [0.25, 0.75]; and
training the ZSL enhancer by iteratively optimizing the loss function of the ZSL enhancer, and using the trained ZSL enhancer as the IEN.

3. The method according to claim 2, wherein the training the ZSL enhancer comprises:
performing a first stage of training on the ZSL enhancer in a manner of input-guided enhancement, comprising: obtaining a single LLI used for iterative training; and inputting the single LLI used for iterative training into the ZSL enhancer to obtain a corresponding expected exposure image; and
performing a second stage of training on the ZSL enhancer in a manner of output-guided refinement, comprising:
storing, in a historical data pool, an expected exposure image obtained through each iterative training in the first stage, and using, as a rough enhanced exposure image output in the first stage, an average value of multiple expected exposure images stored closest to a current moment in the historical data pool; inputting the rough enhanced exposure image into the ZSL enhancer to obtain a corresponding expected exposure image; and storing, in the historical data pool, expected exposure images obtained through each iterative training in the second stage.

4. The method according to claim 2, wherein the light transformation T(•) is gamma correction, and the denoising operation D(•) is a zero-shot denoising operation.

5. An image enhancement apparatus, wherein the apparatus comprises:
an image obtaining module configured to obtain a to-be-processed single LLI; and
an image enhancement module configured to input the to-be-processed single LLI into an IEN, wherein the IEN is obtained by training a ZSL enhancer by defining a prior-guided regularization loss; and obtain an expected exposure image output by the IEN with respect to the to-be-processed single LLI.

6. The apparatus according to claim 5, wherein a process of training, by the image enhancement module, the ZSL enhancer by defining the prior-guided regularization loss to obtain the IEN comprises:
constructing the ZSL enhancer:
$$\overline{R} = {arg min}_{\overline{R}} {‖ I - ( \overline{R} ∘ \overline{L} + N ) ‖}^{2} + {λ}_{1} ψ ( \overline{R} ) + {λ}_{2} φ ( \overline{L} ) + {λ}_{3} ϕ ( N ) ,$$
ψ(R̅)=λ_{T}ψ_{T}(R̅)+λ_{C}ψ_{c}(R̅)+λ_{I}ψ_{I}(R̅); R̅ is the output expected exposure image; L̅ is an output IRM, and meets a piecewise smoothness constraint, L̅=L/\tilde{L}, L is an illumination map, and \tilde{L} is desired illumination; I is an input single LLI, R̅=R∘\tilde{L}, and R is a reflectance map; N is an output noise map; ψ(R̅), φ(L̅), and φ(N) are respectively regularization terms of the output expected exposure image, the output IRM, and the output noise map; λ₁, λ₂, and λ₃ are respectively balance weights of ψ(R̅), φ(L̅), and φ(N), λ₁ is set to 1, λ₂ is set to 0.5, and λ₃ is set to 0.1; and ψ_{T}(R̅), ψ_{c}(R̅), and ψ_{I}(R̅) are respectively a texture regularization term, a color regularization term, and an illumination regularization term;
constructing a loss function of the ZSL enhancer:
Lₐₗₗ=L_{rec}+λ₂L_{L̅}+λ₃L_{N}+λ_{T}L_{T}+λ_{C}L_{C}+λ_{I}L_{I}, where
Lₐₗₗ is an overall loss function; L_{rec} is a reconstruction loss, and L_{rec}=∥I−(R̅∘L̅+N)∥²; L_{L̅} is a regularization loss of the illumination map, L_{L̅}=∥∇I∘ exp(−λ_{g}∇R̅)∥, ∇ is a gradient operator, λ_{g} is a balance factor, and λ_{g} is set to 10; L_{N} is a regularization loss of the output noise map, L_{N}=∥M(N)∥, and M(•) is a function for calculating an input mean; L_{T} is a texture loss, L_{T}=∥F(R̅^{γt})−F(D(T(I)))∥², F(•) is a feature extractor, T(•) is a light transformation, D(•) is a denoising operation, and γt is a learnable factor; L_{C} is a color loss,
$${L}_{C} = , {\sum }_{i = r , g , b} {‖ M ( H ( {\overline{R}}_{i} ) ) - M ( {I}_{i} ) ‖}^{2} + {λ}_{cf} ‖ {E}_{n} - ( v + ω \times μ ) ‖ ,$$
$$μ = \sqrt{{M ( \vert {\overline{R}}_{r} - {\overline{R}}_{g} \vert )}^{2} + {M ( \vert {\overline{R}}_{r} + {\overline{R}}_{g} \vert / 2 - {\overline{R}}_{b} )}^{2}} ,$$
$$v = \sqrt{{S ( \vert {\overline{R}}_{r} - {\overline{R}}_{g} \vert )}^{2} + {S ( \vert {\overline{R}}_{r} + {\overline{R}}_{g} \vert / 2 - {\overline{R}}_{b} )}^{2}} ,$$
H(R̅ᵢ)=(αR̅ᵢ)^{β} is a pixel-to-pixel conversion function, α and β are learnable parameters, and S(•) is a function for calculating an input variance; R̅ᵢ∈{R̅ᵣ,R̅_{g},R̅_{b}} are r, g, and b channels corresponding to R̅, and Iᵢ∈{Iᵣ,I_{g},I_{b}} are r, g, and b channels corresponding to I; λ_{cf} is a constant parameter used to enhance an image color, and is set to 0.025; Eₙ is a constant parameter used to determine a color level of an image, and is set to 0.32; ω is a weight parameter, and is set to 0.3; L_{I} is an illumination loss,
$${L}_{I} = ‖ M ( \overline{R} ) - ε ‖ - {λ}_{il} {\sum }_{i = 1}^{B} S ( {δ}^{i} ( \overline{R} ) ) ,$$
δ(•) is an operation of generating a local image from an input image, B is a quantity of image blocks, λᵢₗ is a parameter used to balance a local contrast of the expected exposure image, and λᵢₗ is set to 2; and ε is a constant parameter set in a range of [0.25, 0.75]; and
training the ZSL enhancer by iteratively optimizing the loss function of the ZSL enhancer, and using the trained ZSL enhancer as the IEN.

7. The apparatus according to claim 6, wherein a process of training, by the image enhancement module, the ZSL enhancer comprises:
performing a first stage of training on the ZSL enhancer in a manner of input-guided enhancement, comprising: obtaining a single LLI used for iterative training; and inputting the single LLI used for iterative training into the ZSL enhancer to obtain a corresponding expected exposure image; and
performing a second stage of training on the ZSL enhancer in a manner of output-guided refinement, comprising:
storing, in a historical data pool, an expected exposure image obtained through each iterative training in the first stage, and using, as a rough enhanced exposure image output in the first stage, an average value of multiple expected exposure images stored closest to a current moment in the historical data pool; inputting the rough enhanced exposure image into the ZSL enhancer to obtain a corresponding expected exposure image; and storing, in the historical data pool, expected exposure images obtained through each iterative training in the second stage.

8. The apparatus according to claim 6, wherein the light transformation T(•) is gamma correction, and the denoising operation D(•) is a zero-shot denoising operation.

9. An electronic device, wherein the electronic device comprises: at least one memory and at least one processor, the memory stores an application program, the processor invokes the application program stored in the memory, and the application program is used to implement the image enhancement method according to claim 1.

10. A non-transitory storage medium, wherein the storage medium stores computer program code, and when being executed, the computer program code implements the image enhancement method according to claim 1.

11. The electronic device according to claim 9, wherein a process of training the ZSL enhancer by defining the prior-guided regularization loss to obtain the IEN comprises:
constructing the ZSL enhancer:
$$\overline{R} = {arg min}_{\overline{R}} {‖ I - ( \overline{R} ∘ \overline{L} + N ) ‖}^{2} + {λ}_{1} ψ ( \overline{R} ) + {A}_{2} φ ( \overline{L} ) + {λ}_{3} ϕ ( N ) ,$$
wherein
ψ(R̅)=λ_{T}ψ_{T}(R̅)+λ_{C}ψ_{c}(R̅)+λ_{I}ψ_{I}(R̅); R̅ is the output expected exposure image; L̅ is an output illumination ratio map (IRM), and meets a piecewise smoothness constraint, L̅=L/\tilde{L}, L is an illumination map, and \tilde{L} is desired illumination; I is an input single LLI, R̅=R∘\tilde{L}, and R is a reflectance map; N is an output noise map; ψ(R̅), φ(L̅), and φ(N) are respectively regularization terms of the output expected exposure image, the output IRM, and the output noise map; λ₁, λ₂, and λ₃ are respectively balance weights of ψ(R̅), φ(L̅), and φ(N), λ₁ is set to 1, λ₂ is set to 0.5, and λ₃ is set to 0.1; and ψ_{T}(R̅), ψ_{c}(R̅), and ψ_{I}(R̅) are respectively a texture regularization term, a color regularization term, and an illumination regularization term;
constructing a loss function of the ZSL enhancer:
Lₐₗₗ=L_{rec}+λ₂L_{L̅}+λ₃L_{N}+λ_{T}L_{T}+λ_{C}L_{C}+λ_{I}L_{I}, where
Lₐₗₗ is an overall loss function; L_{rec} is a reconstruction loss, and L_{rec}=∥I−(R̅∘L̅+N)∥²; L_{L̅} is a regularization loss of the illumination map, L_{L̅}=∥∇I∘ exp(−λ_{g}∇R̅)∥, ∇ is a gradient operator, λ_{g} is a balance factor, and λ_{g} is set to 10; L_{N} is a regularization loss of the output noise map, L_{N}=∥M(N)∥, and M(•) is a function for calculating an input mean; L_{T} is a texture loss, L_{T}=∥F(R̅^{γt})−F(D(T(I)))∥², F(•) is a feature extractor, T(•) is a light transformation, D(•) is a denoising operation, and γt is a learnable factor; L_{C} is a color loss,
$${L}_{C} = , {\sum }_{i = r , g , b} {‖ M ( H ( {\overline{R}}_{i} ) ) - M ( {I}_{i} ) ‖}^{2} + {λ}_{cf} ‖ {E}_{n} - ( v + ω \times μ ) ‖ ,$$
$$μ = \sqrt{{M ( \vert {\overline{R}}_{r} - {\overline{R}}_{g} \vert )}^{2} + {M ( \vert {\overline{R}}_{r} + {\overline{R}}_{g} \vert / 2 - {\overline{R}}_{b} )}^{2}} ,$$
$$v = \sqrt{{S ( \vert {\overline{R}}_{r} - {\overline{R}}_{g} \vert )}^{2} + {S ( \vert {\overline{R}}_{r} + {\overline{R}}_{g} \vert / 2 - {\overline{R}}_{b} )}^{2}} ,$$
H(R̅ᵢ)=(αR̅ᵢ)^{β} is a pixel-to-pixel conversion function, α and β are learnable parameters, and S(•) is a function for calculating an input variance; R̅ᵢ∈{R̅ᵣ,R̅_{g},R̅_{b}} are r, g, and b channels corresponding to R̅, and Iᵢ∈{Iᵣ,I_{g},I_{b}} are r, g, and b channels corresponding to I; λ_{cf} is a constant parameter used to enhance an image color, and is set to 0.025; Eₙ is a constant parameter used to determine a color level of an image, and is set to 0.32; ω is a weight parameter, and is set to 0.3; L_{I} is an illumination loss,
$${L}_{I} = ‖ M ( \overline{R} ) − ε ‖ − {λ}_{i l} {\sum }_{i = 1}^{B} S ( {δ}^{i} ( \overline{R} ) ) ,$$
δ(•) is an operation of generating a local image from an input image, B is a quantity of image blocks, λᵢₗ is a parameter used to balance a local contrast of the expected exposure image, and λᵢₗ is set to 2; and ε is a constant parameter set in a range of [0.25, 0.75]; and
training the ZSL enhancer by iteratively optimizing the loss function of the ZSL enhancer, and using the trained ZSL enhancer as the IEN.

12. The electronic device according to claim 11, wherein the training the ZSL enhancer comprises:
performing a first stage of training on the ZSL enhancer in a manner of input-guided enhancement, comprising: obtaining a single LLI used for iterative training; and inputting the single LLI used for iterative training into the ZSL enhancer to obtain a corresponding expected exposure image; and
performing a second stage of training on the ZSL enhancer in a manner of output-guided refinement, comprising:
storing, in a historical data pool, an expected exposure image obtained through each iterative training in the first stage, and using, as a rough enhanced exposure image output in the first stage, an average value of multiple expected exposure images stored closest to a current moment in the historical data pool; inputting the rough enhanced exposure image into the ZSL enhancer to obtain a corresponding expected exposure image; and storing, in the historical data pool, expected exposure images obtained through each iterative training in the second stage.

13. The electronic device according to claim 11, wherein the light transformation T(⋅) is gamma correction, and the denoising operation D(⋅) is a zero-shot denoising operation.

14. The non-transitory storage medium according to claim 10, wherein a process of training the ZSL enhancer by defining the prior-guided regularization loss to obtain the IEN comprises:
constructing the ZSL enhancer:
$$\overline{R} = {arg min}_{\overline{R}} {‖ I - ( \overline{R} ∘ \overline{L} + N ) ‖}^{2} + {λ}_{1} ψ ( \overline{R} ) + {λ}_{2} φ ( \overline{L} ) + {λ}_{3} ϕ ( N ) ,$$
ψ(R̅)=λ_{T}ψ_{T}(R̅)+λ_{C}ψ_{c}(R̅)+λ_{I}ψ_{I}(R̅); R̅ is the output expected exposure image; L̅ is an output illumination ratio map (IRM), and meets a piecewise smoothness constraint, L̅=L/\tilde{L}, L is an illumination map, and \tilde{L} is desired illumination; I is an input single LLI, R̅=R∘\tilde{L}, and R is a reflectance map; N is an output noise map; ψ(R̅), φ(L̅), and φ(N) are respectively regularization terms of the output expected exposure image, the output IRM, and the output noise map; λ₁, λ₂, and λ₃ are respectively balance weights of ψ(R̅), φ(L̅), and φ(N), λ₁ is set to 1, λ₂ is set to 0.5, and λ₃ is set to 0.1; and ψ_{T}(R̅), ψ_{c}(R̅), and ψ_{I}(R̅) are respectively a texture regularization term, a color regularization term, and an illumination regularization term;
constructing a loss function of the ZSL enhancer:
Lₐₗₗ=L_{rec}+λ₂L_{L̅}+λ₃L_{N}+λ_{T}L_{T}+λ_{C}L_{C}+λ_{I}L_{I}, where
Lₐₗₗ is an overall loss function; L_{rec} is a reconstruction loss, and L_{rec}=∥I−(R̅∘L̅+N)∥²; L_{L̅} is a regularization loss of the illumination map, L_{L̅}=∥∇I∘ exp(−λ_{g}∇R̅)∥, ∇ is a gradient operator, λ_{g} is a balance factor, and λ_{g} is set to 10; L_{N} is a regularization loss of the output noise map, L_{N}=∥M(N)∥, and M(•) is a function for calculating an input mean; L_{T} is a texture loss, L_{T}=∥F(R̅^{γt})−F(D(T(I)))∥², F(•) is a feature extractor, T(•) is a light transformation, D(•) is a denoising operation, and γt is a learnable factor; L_{C} is a color loss,
$${L}_{C} = , {\sum }_{i = r , g , b} {‖ M ( H ( {\overline{R}}_{i} ) ) - M ( {I}_{i} ) ‖}^{2} + {λ}_{cf} ‖ {E}_{n} - ( v + ω \times μ ) ‖ ,$$
$$μ = \sqrt{{M ( \vert {\overline{R}}_{r} - {\overline{R}}_{g} \vert )}^{2} + {M ( \vert {\overline{R}}_{r} + {\overline{R}}_{g} \vert / 2 - {\overline{R}}_{b} )}^{2}} ,$$
$$v = \sqrt{{S ( \vert {\overline{R}}_{r} - {\overline{R}}_{g} \vert )}^{2} + {S ( \vert {\overline{R}}_{r} + {\overline{R}}_{g} \vert / 2 - {\overline{R}}_{b} )}^{2}} ,$$
H(R̅ᵢ)=(αR̅ᵢ)^{β} is a pixel-to-pixel conversion function, α and β are learnable parameters, and S(•) is a function for calculating an input variance; R̅ᵢ∈{R̅ᵣ,R̅_{g},R̅_{b}} are r, g, and b channels corresponding to R̅, and Iᵢ∈{Iᵣ,I_{g},I_{b}} are r, g, and b channels corresponding to I; λ_{cf} is a constant parameter used to enhance an image color, and is set to 0.025; Eₙ is a constant parameter used to determine a color level of an image, and is set to 0.32; ω is a weight parameter, and is set to 0.3; L_{I} is an illumination loss,
$${L}_{I} = ‖ M ( \overline{R} ) − ε ‖ − {λ}_{i l} {\sum }_{i = 1}^{B} S ( {δ}^{i} ( \overline{R} ) ) ,$$
δ(═) is an operation of generating a local image from an input image, B is a quantity of image blocks, λᵢₗ is a parameter used to balance a local contrast of the expected exposure image, and λᵢₗ is set to 2; and ε is a constant parameter set in a range of [0.25, 0.75]; and
training the ZSL enhancer by iteratively optimizing the loss function of the ZSL enhancer, and using the trained ZSL enhancer as the IEN.

15. The non-transitory storage medium according to claim 14, wherein the training the ZSL enhancer comprises:
performing a first stage of training on the ZSL enhancer in a manner of input-guided enhancement, comprising: obtaining a single LLI used for iterative training; and inputting the single LLI used for iterative training into the ZSL enhancer to obtain a corresponding expected exposure image; and
performing a second stage of training on the ZSL enhancer in a manner of output-guided refinement, comprising:
storing, in a historical data pool, an expected exposure image obtained through each iterative training in the first stage, and using, as a rough enhanced exposure image output in the first stage, an average value of multiple expected exposure images stored closest to a current moment in the historical data pool; inputting the rough enhanced exposure image into the ZSL enhancer to obtain a corresponding expected exposure image; and storing, in the historical data pool, expected exposure images obtained through each iterative training in the second stage.

16. The non-transitory storage medium according to claim 14, wherein the light transformation T(•) is gamma correction, and the denoising operation D(•) is a zero-shot denoising operation.
